(19) United States
(12) Patent Application Publication
(10) Pub. No.: US 2026/0031664 A1
(43) Pub. Date: Jan. 29, 2026

(54) RARE-EARTH-FREE PERMANENT MAGNET MOTOR

(71) Applicant: University of Pittsburgh - Of the Commonwealth System of Higher Education, Pittsburgh, PA (US)

(72) Inventors: Ryan Michael Brody, Pittsburgh, PA (US); Mohendro Kumar Ghosh, Pittsburgh, PA (US); Brandon Michael Grainger, Pittsburgh, PA (US); Paul Richard Ohodnicki, Allison Park, PA (US); Jangho Yun, Pittsburgh, PA (US)

(73) Assignee: University of Pittsburgh - Of the Commonwealth System of Higher Education, Pittsburgh, PA (US)

(21) Appl. No.: 19/281,373

(22) Filed: Jul. 25, 2025

Related U.S. Application Data
(60) Provisional application No. 63/676,204, filed on Jul. 26, 2024.

(51) Int. Cl. H02K 1/02; H02K 1/2795; H02K 21/20

(52) U.S. Cl. CPC H02K 1/02; H02K 1/2795; H02K 21/20

(57) ABSTRACT

Permanent magnet synchronous motors (PMSMs) may utilize various permanent magnet (PM) materials, including those that do not contain rare earth (RE) elements. RE-free PMs show some potential in permanent magnet synchronous motors (PMSMs) compared to RE PMs, but some PMs show an increased risk of irreversible demagnetization at lower temperatures. In some cases, as in Manganese bismuth (MnBi) surface permanent magnet synchronous motors (SPMSM), the low temperature demagnetization risk significantly impacts the torque and power density. Due to this, somewhat unconventional stator tooth geometries are used to achieve competitive torque and power densities in SPMSMs. Because conventional approaches to machine design do not consider these factors, a set of guidelines are provided for stator teeth configurations that reduce the risk of irreversible demagnetization in slotted motors.

### CROSS-REFERENCE TO RELATED APPLICATIONS

This application claims the benefit of U.S. Provisional Application No. 63/676,204 filed Jul. 26, 2024, which is incorporated by reference herein.

### ACKNOWLEDGMENT OF GOVERNMENT SUPPORT

This invention was made with government support under Grant No. DE-SC0021745 awarded by the U.S. Department of Energy. The government has certain rights in the invention.

### FIELD

This disclosure is related to the field of permanent magnet motors.

### BACKGROUND

Over the past decade, significant research effort has explored motor designs that maximize torque density, power density, and efficiency without using permanent magnets (PMs) containing rare-earth (RE) elements, such as Neodymium Iron Boron (NdFeB). While such PMs tend to yield interior permanent magnet synchronous motor (IPMSM) designs with exceptional performance while maintaining reasonable cost and manufacturability, recent supply squeezes have caused significant price fluctuations for RE PMs. In certain critical applications like electric transportation, NdFeB PM cost already constitutes a large portion of the motor cost despite being a small portion of the mass, even without consideration of the supply chain risks and potential price fluctuations. This motivates a desire for RE-free alternatives.

### SUMMARY

The disclosure describes configurations of rare-earth-free permanent magnet motors that consider irreversible demagnetization. Disclosed examples use an iterative multi-objective optimization (MOO) design procedure to control the risk of irreversible demagnetization (including temperature-dependent irreversible demagnetization), which is particularly challenging in rare earth (RE) free/lean PMSMs, by tuning the permeance of flux paths in permanent magnet synchronous motors (PMSMs). Manganese Bismuth (MnBi) is a new permanent magnet (PM) material with a relatively high energy density at high temperatures compared to other RE-free PMs (e.g., which may result in the MnBi magnet outperforming existing, commercially available, RE-free alternatives, namely ferrite PMs), but also a uniquely high susceptibility to irreversible demagnetization at low temperatures (e.g., near and below room temperature). Due to this tradeoff, this disclosure is useful in MnBi PMSM design to mitigate irreversible demagnetization risk at low temperatures. However, the technologies described herein may apply to PMSMs that use other PM materials, with different temperature ranges depending on the PM material. For example, the disclosure applies to ferrite PMSMs at low temperatures in a similar manner as the MnBi PMSM. In additional or alternative examples, the technologies of this disclosure may be applied to PMSMs with RE PMs, such as NdFEB, to mitigate irreversible demagnetization risk at high temperatures, and the effects may be less significant to saturation caused by high remanent flux density. By applying the technologies of this disclosure to PMSMs with RE PMs, RE PMs may be selected to have lower volume and/or mass than typically used, while still exhibiting increased performance relative to other approaches to PMSM design, which results in reduced overall costs and RE material usage.

To demonstrate the benefit of the disclosed configurations and approaches for MnBi PMSMs, a 1 kW MnBi surface permanent magnet synchronous motor (SPMSM) is provided as a case study for one possible motor type for which the disclosed technologies are applicable, where the shape of the stator teeth/slots are optimized to control the risk of demagnetization at room temperature. In PMSMs, stator slotting modulates the air gap flux from the rotor permanent magnets such that flux concentrates around the stator teeth. The resultant dips in air gap flux density around slot openings can cause irreversible demagnetization in RE-free SPMSMs, even at open circuit with no rotation depending on the permanent magnet material and temperature. This method showed that using thicker stator teeth with larger tooth tips and smaller slot openings minimizes these air gap flux density dips, although this is unconventional in RE-free PMSM design because it can possibly degrade torque density, power density, and flux weakening capabilities by decreasing electric loading and increasing leakage path permeance, especially in the case of designs that are not fully optimized. Higher torque and efficiency may be observed in fully optimized designs that include semi-closed slots or other methods of enabling a more uniform flux density in the PM, due to a higher effective gap field and reduced effective gap distance (assuming other parameters are maintained, as typically calculated, for example using the Carter coefficient in the case of motors with slots). This applies to all PMSM motors to mitigate the demagnetization effect. An example uses the RE-free PMSM, which is more susceptible to irreversible demagnetization at low temperatures. Another example uses the RE PMSM, which is more susceptible to irreversible demagnetization at high temperatures. The basic principle of minimizing flux variation is broadly relevant to PMSMs, however, the degree to which the technologies of this disclosure impacts the design and the demagnetization risk depends on the exact PM material used (e.g., material properties), the range of operating temperatures, and/or other parameters of the PMSMs.

A further example includes the RE-free SPMSMs, which are particularly susceptible to irreversible demagnetization because RE-free PMs with relatively low coercivity are directly exposed to slotting harmonics in the airgap flux density that the technologies of this disclosure mitigate. MnBi PMs have the potential to replace ferrite PMs in RE-free/lean motors, but MnBi has a unique property where coercivity significantly increases with temperature, making irreversible demagnetization a much greater risk at low temperatures (e.g., room temperature and below). Therefore, another example is the MnBi SPMSM utilizing the unconventional stator tooth design mentioned above in addition to carefully optimized rotor geometries to yield competitive power densities. This example is significantly impacted by temperature dependent irreversible demagnetization due to slotting effects. Therefore, this disclosure uses this example as a case study for the efficacy of the invention. Furthermore, while the case study here focuses on “semi-closed” slots (i.e., a non-zero slot opening), another example includes “slotless” motors (i.e., a slot opening of 0 mm) or motors with magnetic slot wedges in the slots.

The disclosed methodology enables considering a large number of geometric parameters when optimizing RE free/lean SPMSMs. For the 1 kW MnBi SPMSM prototype, these parameters include, but are not limited to: magnet arc ratio (the ratio of the arc spanned at the rotor outer diameter by one permanent magnet to the arc spanned by one pole at the same diameter), magnet reduction (decreasing magnet thickness at the edges compared to the center), magnet radial thickness (for radial flux motors), slot opening ratio (ratio of slot opening to slot width), slot depth ratio (ratio of slot radial length to total stator radial thickness), tooth width ratio (ratio of tooth width to slot pitch), airgap length, and the angle of the tooth tip. While other sources may use some of these parameters at best, no sources include all of these variables in their study. Furthermore, this methodology can easily be adapted to other machine topologies, as the inventors have also used it to shape the bridges, posts, and flux barriers in addition to the stator teeth/slots (all simultaneously) in interior permanent magnet synchronous motors (IPMSMs) and PM assisted synchronous reluctance motors (PMASynRM).

In addition to considering a wide scope of geometric parameters, the disclosure also provides that certain parameters have a much more significant impact on irreversible demagnetization than others. In particular, for a 1 kW MnBi SPMSM prototype in one example, the magnets must have a tooth width ratio greater than about 0.2, a slot opening ratio less than about 0.25, and a magnet thickness between about 8 mm and 15 mm to not irreversibly demagnetize at 0° C. for up to the rated current. In some examples, a magnet thickness may be selected as a ratio to air gap length to prevent irreversible demagnetization at 0° C. for up to the rated current. For example, a ratio of magnet thickness to air gap length of 13.559 to 25.424 (for an air gap length of 0.59 mm) may achieve the above-described prevention of irreversible demagnetization in some scenarios. Of these variables, the slot opening and tooth width ratio have the most significant impact. Other designs in literature have not considered all of these parameters together when optimizing a PMSM design with respect to demagnetization risk, nor have any successfully controlled irreversible demagnetization to completely eliminate irreversible demagnetization risk under predefined operating conditions in RE free/lean PMSM or RE PMSMs.

In fact, some of the ranges used above could be considered slightly unconventional for RE free/lean motor design, but this invention revealed their advantages. For example, tooth width is often considered in any permanent magnet motor design, but the large tooth thicknesses suggested here are not typically used in torque dense RE free/lean designs because they are conventionally expected to result in low tooth flux density and electric loading for designs that are not fully optimized. Additionally, magnet thickness is thought to increase airgap flux density and thus torque density in SPMSMs, but this invention revealed that increasing magnet thickness beyond a certain threshold (e.g., 15 mm for the 1 kW design, or a ratio of 25.424 times the air gap length of 0.59 mm) inevitably leads to partial irreversible demagnetization. Furthermore, the airgap thickness is slightly larger (0.59 mm) than the standard thickness for this power level (0.4 mm) to decrease low temperature irreversible demagnetization risk. The results disclosed here apply specifically to an example 1 kW MnBi SPMSM prototype, but the invention can apply to higher power PMSMs and IPMSM and PMASynRM topologies, though the most impactful variables and their ranges will differ.

Design methods for avoiding irreversible demagnetization in RE free PMSMs can include: 1. Method 1: Approximate the risk of demagnetization using magnetic equivalent circuits (MEC) that assume a uniform average PM flux density over some segment(s) of the PM and use that average PM flux density to assess irreversible demagnetization risk within the segment(s). By assuming uniform PM flux densities, this method fails to fully eliminate partial irreversible demagnetization and therefore requires a large margin of error. Small margins of error require more accurate MECs, which quickly become complex and possibly infeasible due a large number of variables, nonlinearities and computational limitations. 2. Method 2: Decrease maximum current to lower maximum demagnetizing field strength, and then increase motor volume and maximum voltage to offset the decrease of torque/power due to lowering the maximum current. This method decreases power/torque density and also affects other performance metrics.

These two methods can be used together or separately. This disclosure combines elements of both methods but differs in both scope and specificity. For example, MECs may be used, as long as they are sufficiently advanced MECs that capture the variation in flux within the PM and the gap. As another option, finite element analysis (FEA) models may be used, but are computationally expensive. The disclosed approaches may alternatively include the use reduced order models (ROMs) of FEA models to control irreversible demagnetization. For example, the ROMs allow using FEA-based predictions and spatial variation of flux calculations with more computational efficiency than pure FEA approaches. Although this can utilize more computation time than using MECs, this method is far more accurate and flexible while still computationally practical. Any of the above example approaches may be used, based on the degree to which spatial variations in flux density are mitigated in terms of their impact on demagnetization and other adverse impacts on performance. As a result, the approaches of this disclosure can also consider far more variables than in other methods from literatures, and can specify critical variable ranges for eliminating irreversible demagnetization. It has shown that some variables thought to be inconsequential for demagnetization (tooth width, airgap thickness, etc.) can be quite important. One goal of the disclosed approaches is to develop the most generalized set of constraints possible (e.g., applying to as wide a variety of machine topologies and power levels as possible) when designing rare-earth free/lean permanent magnet motors. Even with a large number of variables, the disclosure provides FEA results that predict that this design methodology completely eliminates irreversible demagnetization under the conditions specified by the designer, which no other design methodology in literature has been found to accomplish.

The designer also has full control over said conditions for which demagnetization risk must be eliminated and can include multiple demagnetization conditions. Therefore, rather than reducing the rated current and increasing size as in Method 2, the motor can be optimized such that current needs to be derated below specified limits only at specified temperatures and yet can be safely operated at rated current continuously above a different specified temperature. This is common when avoiding high temperatures in things like winding insulation, but this concept has yet to be used to mitigate low temperature irreversible demagnetization in RE-free PMs. As best understood, no group has proposed doing this to date due to difficulties in accurately assessing demagnetization in the design process and also associated control challenges when testing the motor. However, as stated before, the technologies of this disclosure apply to all PMSMs. For example, it applies to ferrite PMSMs to prevent low temperature demagnetization, although to a lesser extent because ferrite BH characteristics do not change with temperature as significantly as in MnBi PMs. Furthermore, the technologies of this disclosure apply to RE PMSM, such as NdFEB PMSMs, at high temperatures, although to a lesser extent due to saturation caused by high remanent flux density in RE PMs. Similarly, the case study here focuses on motors with “semi-closed” slot openings, however, the technologies of the disclosure may similarly apply to “slotless” motors and motors with magnetic slot wedges. The technologies of the disclosure also apply to the IPMSM topology, although again to a lesser extent because the rotor laminations somewhat protect the PMs magnetically from demagnetization due to slotting harmonics.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 shows an example of a permanent magnet BH curve before and after irreversible demagnetization.

FIGS. 2A and 2B show example comparisons of demagnetization curves of MnBi permanent magnets to those of typical rare-earth and rare-earth-free permanent magnets at low and high temperatures.

FIGS. 3A and 3B show examples of slotting effects and flux leakage impacting permanent magnet flux density distribution.

FIG. 4 shows an example slot geometry for a motor with no tooth tips.

FIG. 5 shows an example slot geometry for a motor with rectangular tooth tips.

FIG. 6 shows an example slot geometry for a motor having tooth tips with a non-zero tooth tip angle.

FIG. 7 shows an example plot of relative permeability of M19 29 gauge steel.

FIG. 8 shows an example of a magnetic equivalent circuit used over one slot pitch.

FIG. 9 shows another example of a magnetic equivalent circuit used over one slot pitch.

FIG. 10 shows an example plot comparing air gap flux density calculated by both a finite element analysis and a magnetic equivalent circuit.

FIGS. 11A-11C show example plots comparing air gap flux density in motor configurations with thick teeth and no teeth tips to motor configurations with equal slot and tooth width and large teeth tips for different slot opening widths.

FIGS. 12A and 12B show example plots of an effect of tooth tip depth on self-demagnetization due to saturation.

FIG. 13 shows an example plot of an effect of magnet depth on self-demagnetization.

FIG. 14 shows an example plot of an effect of air gap length on self-demagnetization.

FIGS. 15A and 15B shows an example plot of an effect of magnet width on self-demagnetization for all rotor poles and for the rotor poles with the greatest risk of demagnetization.

FIG. 16 shows an example visualization of a demagnetization ratio for combinations of tooth width ratio and slot opening ratio.

FIGS. 17A and 17B show 3-D FE models of inner stator dual sided rotor and inner rotor dual sided stator geometries.

FIGS. 18A and 18B show stator windings of inner stator dual sided rotor and inner stator dual sided stator geometries (Phase A, Phase B, Phase C).

FIGS. 19A and 19B show open slots, semi-closed slots and magnetic wedges in inner stator dual sided rotor and inner rotor dual sided stator geometries.

FIG. 20 shows the value of λₚₘ by semi-closed slots and magnetic wedges in inner stator dual sided rotor geometry.

FIGS. 21A-21D show stator magnetic flux density of open slot, semi-closed slot (8 mm), semi-closed slot (4 mm), and magnetic wedge models in inner stator dual sided rotor under no-load conditions.

FIG. 22 shows L_{d} of inner stator dual sided rotor and inner rotor dual sided stator geometries.

FIGS. 23A and 23B show the value of λₚₘ by semi-closed slots and magnetic wedges in inner stator dual sided rotor geometry.

FIGS. 24A-24C show example distribution of magnetic flux density and eddy current loss of a single pole PM in open slot, semi-closed slot, and magnetic wedge models in inner stator dual sided rotor geometry.

FIGS. 25A-25C show distribution of magnetic flux density and eddy current loss of a single pole PM in open slot, semi-closed slot, and magnetic wedge models in inner rotor dual sided stator geometry.

FIG. 26 shows stator magnetic flux density distribution of inner rotor dual sided stator motor under rated load conditions.

### DETAILED DESCRIPTION

### I. Introduction

One approach to configuring motors, for example at reduced cost relative to other approaches, includes using alternative PM materials that do not contain RE elements (like ferrites or, more recently, MnBi). However, these materials have an increased susceptibility to irreversible demagnetization at low temperatures (rather than at high temperatures as with NdFeB). While high temperatures can be avoided in PMSMs by carefully designing the motors and their cooling systems, operating at and below room temperature often cannot be avoided in practice. For this reason, low temperature performance must be carefully considered for some RE-free PMs (e.g., ferrites and MnBi-based PMs) to mitigate demagnetization. Furthermore, MnBi experiences a much more significant change in demagnetization risk with temperature compared to ferrites because MnBi has an exceptionally large, positive temperature coefficient for coercivity. Still, temperature-dependent demagnetization is useful to consider in ferrite PMSMs at low temperatures and RE PMSMs at high temperatures, in addition to MnBi PMSMs.

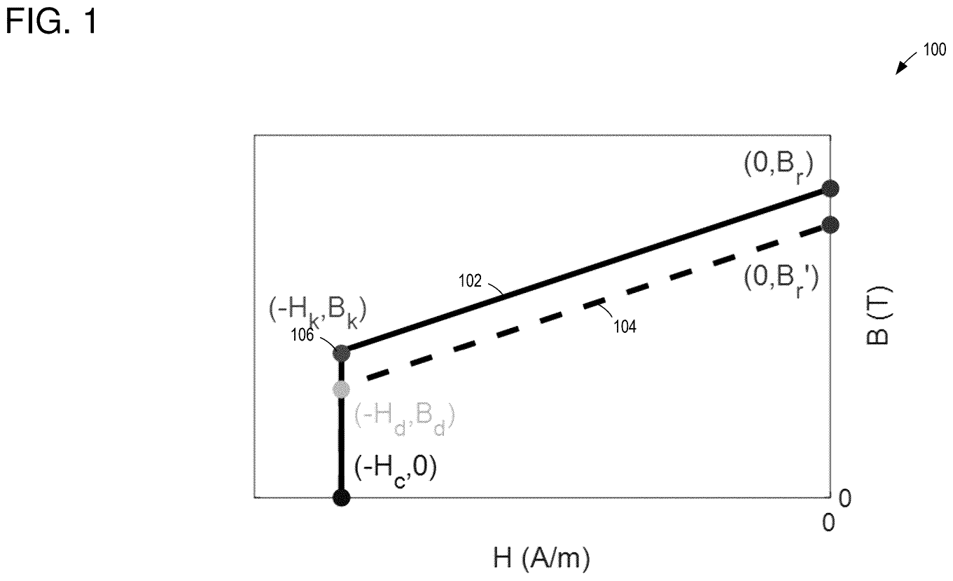

FIG. 1 shows a plot 100 of an example PM demagnetization curve before (shown by the solid line 102) and after (shown by the dashed line 104) irreversible demagnetization. The vertical and horizontal intercepts represent PM remanent flux density (Bᵣ) and coercivity (H_{c}), respectively. The “knee” of the BH curve, denoted in FIG. 1 by the magenta point 106 (−Hₖ, Bₖ), divides the PM operating points which lead to either reversible or irreversible demagnetization. When the flux density decreases below Bₖ (or equivalently, the magnetic field intensity decreases below −Hₖ), irreversible demagnetization occurs, thereby demagnetizing the magnets. In this case, some PM dipoles begin to lose alignment with one another, and when the external field is removed, unaligned PM dipoles do not realign with the PM magnetization. As an example, if the PM flux density decreases below Bₖ to the value Ba in FIG. 1 (or equivalently, if the external magnetic field decreases beyond −Hₖ to −H_{d}), the PM BH curve will then resemble the dashed black line in FIG. 1, rather than the solid black line. This leads to a remanent flux density reduction from Bᵣ to B′ᵣ.

For most PM materials, the BH slope between −Hₖ and 0 A/m does not change with temperature while H_{c}≅Hₖ, and the slope between −Hₖ and −H_{c} is very high. As a result, H_{c} and Bᵣ primarily dictate Bₖ and thus the susceptibility of irreversible demagnetization.

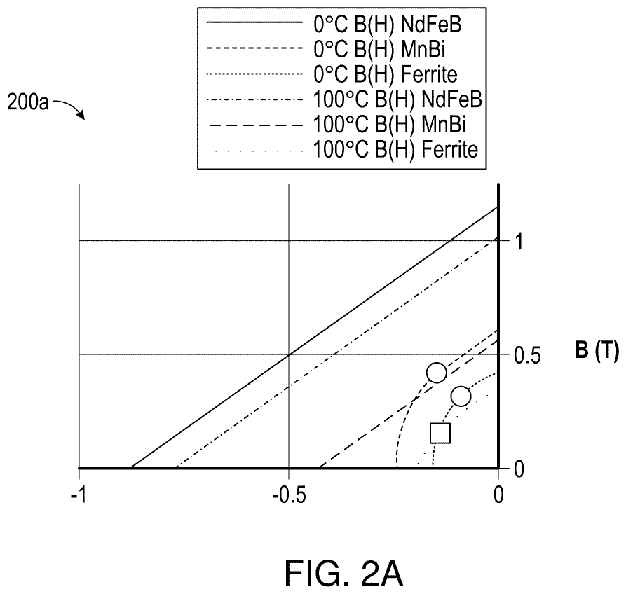

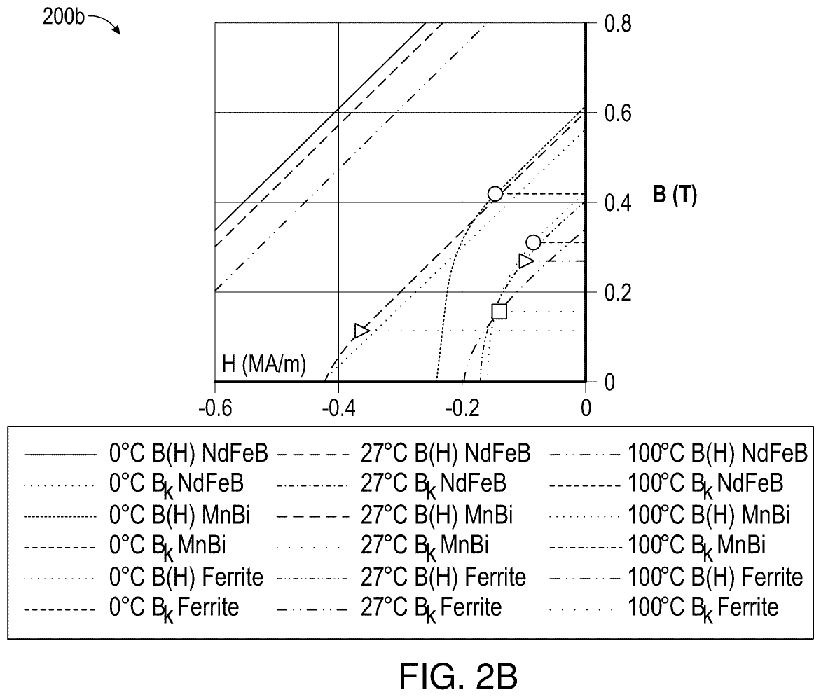

However, temperature affects both H_{c} and Bᵣ, in turn affecting Bₖ. FIGS. 2A and 2B show plots 200a and 200b, respectfully, comparing the effect of temperature on the demagnetization curves of a MnBi PM, a typical RE PM (NdFEB N30UH), and a typical, commercially available, RE-free PM (Y32 ferrite). Because RE PMs generally have much larger H_{c} than RE-free PMs, FIG. 2A shows all three PM materials while FIG. 2B focuses on only the RE-free PMs. Data for the NdFeB and ferrite PM results from first testing, data for MnBi at 27° C. and 100° C. results from second testing, and the MnBi BH data at 0° C. is extrapolated using higher temperature data from and BH curve fitting techniques.

All PM materials have Bᵣ that decreases as temperature increases. For the ferrite PM in FIGS. 2A and 2B, decreasing Bᵣ with temperature causes a decrease in Bₖ despite a slight increase in H_{c} with temperature. On the other hand, MnBi has the unique property of significantly increasing H_{c} with temperature, which causes Bₖ to decrease significantly with decreasing temperature, leading to a much greater risk of irreversible demagnetization near and below room temperature. In fact, the degree to which H_{c} changes with temperature is similar in MnBi and NdFEB magnets. However, H_{c} in NdFEB decreases with increasing temperature rather than increasing with increasing temperature like in MnBi. Furthermore, the MnBi PM has a coercivity similar to the NdFeB PM at 100° C. yet similar to the ferrite PM at 27° C. This leads to a significant change in demagnetization risk throughout typical motor operating temperatures.

In a slotted motor, the flux path permeances are not constant in the air gap causing flux to concentrate near the stator teeth. This consequently increases air gap flux density near stator teeth and tooth tips while decreasing near stator slot opening. Additionally, flux leaking from magnet to magnet along the edges of the magnet decreases the local PM flux density at the magnet corners adjacent to the airgap compared to the center of the PM. This disclosure aims to show how both effects exacerbate demagnetization risk and proposes design guidelines to minimize demagnetization risk.

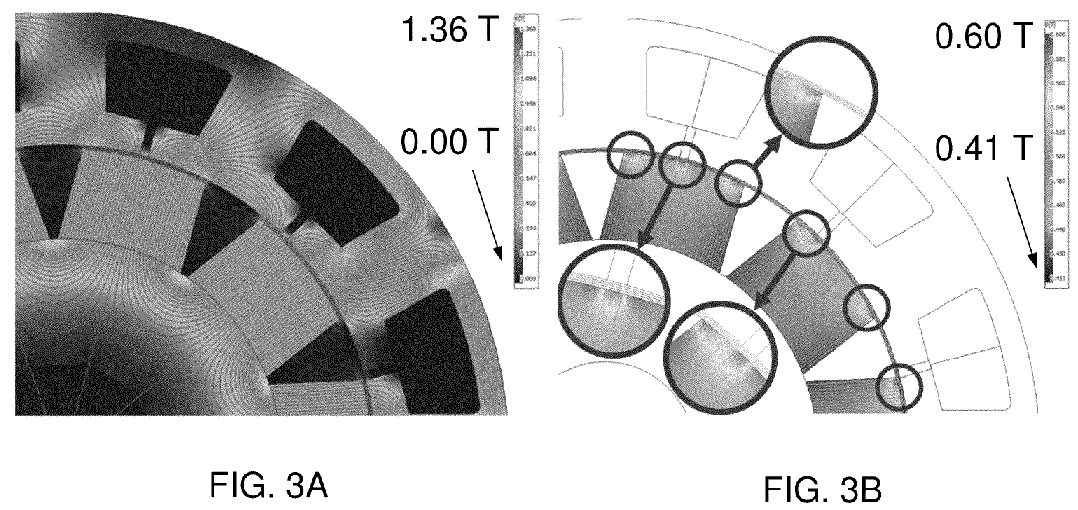

FIGS. 3A and 3B show an example of these flux concentrations (circled in FIG. 3B) using finite element analysis (FEA) for a 12-slot, 10-pole, 1 KW, 33 A MnBi SPMSM. FIG. 3A shows an example in FEA of slotting effects in flux leakage impacting permanent motor flux density distribution color coding the entire motor, while in FIG. 3B only the permanent magnets are color coded and the dips in permanent magnet flux density are circled. In interior permanent magnet synchronous motors (IPMSMs), the rotor steel can somewhat protect the PMs, where tuning the leakage path permeance by adjusting the dimensions of the magnet bridges and posts can control risk of irreversible demagnetization. However, mounting PMs on the rotor surface in SPMSMs directly exposes the PMs to the air gap flux density providing limited means by which to mitigate demagnetization.

Some have shown that fluctuations in air gap flux density due to slotting effects can lead to irreversible demagnetization in SPMSMs and IPMSMs, yet none have proposed simple stator tooth design guidelines to lower risk of irreversible demagnetization due to slotting effects (e.g., air gap flux density modulation). Therefore, this disclosure proposes simple design rules for the stator teeth to mitigate demagnetization risk, focusing on the impact in the MnBi SPMSM here due to the significantly increased low temperature demagnetization risk for this type of motor. However, the design methodology described herein also applies to other RE, RE-lean, and RE-free PMSMs that suffer from temperature-dependent irreversible demagnetization. Additionally, the proposed guidelines will also apply to IPMSMs, although with less impact than in SPMSMs.

Disclosed are descriptions of using a magnetic equivalent circuit (MEC) to demonstrate the relationships between stator tooth design and irreversible demagnetization via air gap flux density modulation. Further disclosed are descriptions of using the MEC to elucidate stator tooth design principles that decrease demagnetization risk in PMSMs. Still further disclosed are descriptions of using an FEA sensitivity study to validate the MEC predictions. The results of the sensitivity study serve as design guidelines for mitigating irreversible demagnetization risk in torque dense MnBi SPMSMs. Guidelines pertain to the tooth/slot width and the slot opening width/depth, although other variables, like magnet thickness/width and air gap length, also impact demagnetization to a lesser extent so are also disclosed. Similar guidelines may apply to ferrite SPMSMs and to other RE-free SPMSMs designed for lower/higher power output. The guidelines are also relevant in the NdFEB SPMSM, though the effect of stator slotting on irreversible demagnetization risk is somewhat diminished in these designs due to increased saturation in the stator teeth cause by high PM remanent flux density. Finally, the guidelines are also relevant in IPMSM designs, although again, this is to a lesser extent than in RE-free SPMSM designs because the rotor laminations somewhat protect the PMs magnetically from slotting effects that lead to irreversible demagnetization.

### II. Relating Stator Tooth Tip Design to SPMSM Irreversible Demagnetization

This section reviews the physics linking air gap flux modulation due to stator tooth tips to temperature dependent irreversible demagnetization in rotor PMs. Example materials for the stator and/or rotor cores of the disclosed examples include, but are not limited to M19 steel or other grades of silicon and/or electrical steels, cobalt and nickel alloys, metal amorphous nano composites, amorphous alloys, nanocrystalline alloys, and/or other compositions.

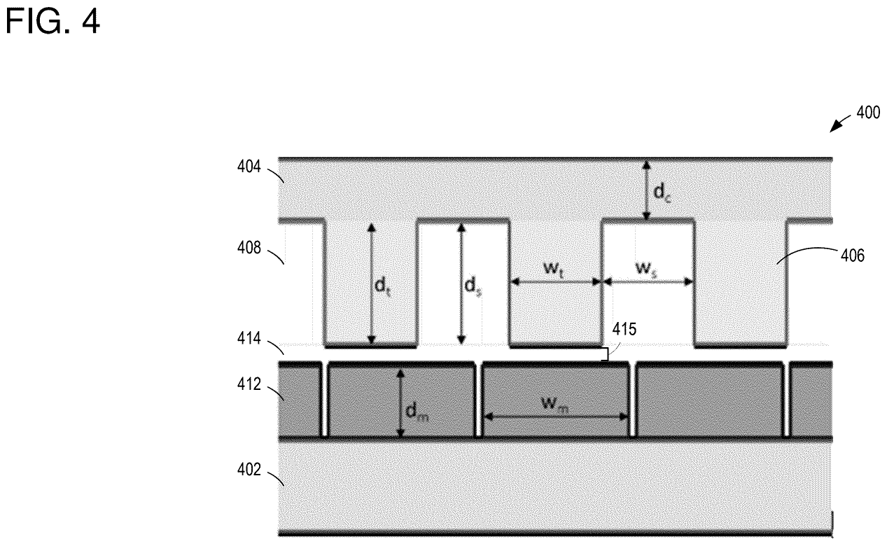

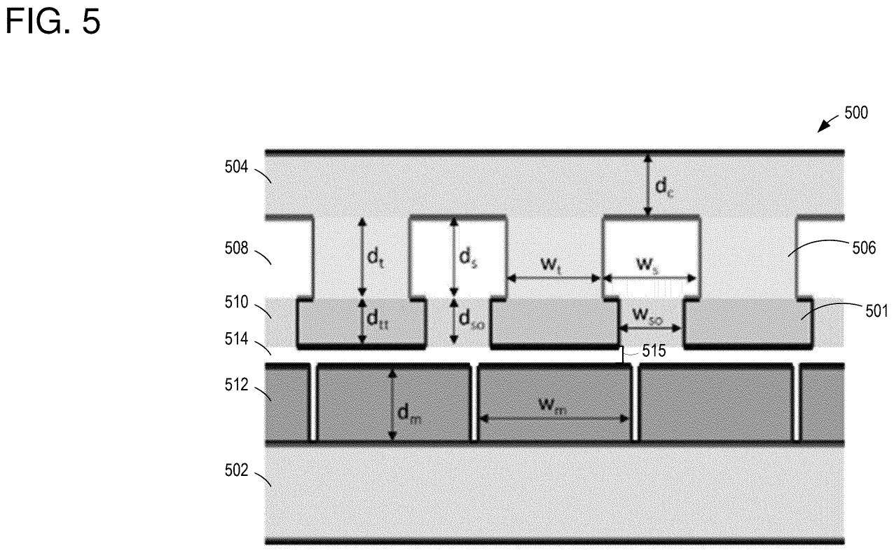

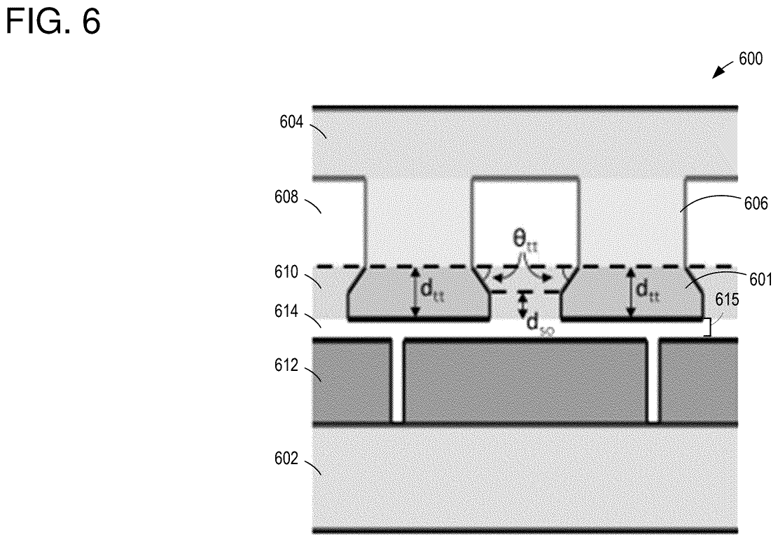

In some examples, the same material is used in the teeth, teeth tips, and stator core. However, the disclosed technologies may also be applicable in configurations in which different core materials are used in different parts of the motor. While some studies simplify the analysis by focusing on the geometry 400 in FIG. 4, these designs do not have the so-called “tooth tips” (sometimes referred to as “semi-closed slots”), as the design in FIG. 5 does (e.g., tooth tips 501 and 601 of FIGS. 5 and 6, respectively). Similarly, in FIGS. 4-6, areas include the rotor or stator core (e.g., rotor core 402, 502, and 602 or stator core 404, 504, and 604 in FIGS. 4-6, respectively), the stator teeth (e.g., stator teeth 406, 506, and 606 in FIGS. 4-6, respectively), the stator slots (e.g., stator slots 408, 508, and 608 in FIGS. 4-6, respectively), the slot openings (e.g., slot openings 510 and 610 in FIGS. 5 and 6, respectively), the PMs (e.g., permanent magnets 412, 512, and 612 in FIGS. 4-6, respectively), and the air gap and spaces between adjacent magnets (e.g., air gaps 414, 514, and 614 in FIGS. 4-6, respectively, where an air gap length, represented for example at 415, 515, and 615 of FIGS. 4, 5, and 6, respectively, is defined as the height of the air gaps, also defined as the distance between a distal end of a tooth (e.g., the distal end of the tooth being opposite the stator core) and a distal end of an opposing permanent magnet (the distal end of the opposing permanent magnet being opposite the rotor core). Results show that the tooth tip configuration and/or geometry significantly impacts irreversible demagnetization risk. Therefore, this disclosure focuses on the stator tooth geometry in FIG. 5. However, the conclusions extend to the geometry in FIG. 4 by letting dₜₜ=dₛₒ=0 and wₛₒ=wₛ, and also to slotless motors by letting wₛₒ=0. A magnetic wedge can also be included in the slot opening, typically with a permeability somewhat slower than teeth yet substantially higher than free space. Flux density modulation for motors with magnetic wedges behaves similarly to slotless motors, though with some differences in performance due to the differences in permeability between the magnetic wedge and the teeth.

Here, wₜ and wₛ are the tooth and slot width ratios, respectively, both normalized such that wₜ+wₛ=1. For example, stator teeth 406/506/606 extend in a first direction from the stator core 402/502/602 toward the permanent magnets 412/512/612 and the rotor core 402/502/602 (such that a tooth width is a width of the tooth in a second direction that is perpendicular to the first direction), and adjacent teeth of the stator teeth are separated from one another by the stator slots 408/508/608 that have a slot width extending between edges of the adjacent teeth. As used herein, wₜ and wₛ are, respectively, the tooth width and the slot width normalized to 1 as noted above. Similarly, wₛₒ is slot opening width ratio, also normalized such that 0≤wₛₒ≤wₛ<1. Similarly, wₘ is the magnet width ratio normalized by the pole pitch such that 0≤wₘ≤1. Furthermore, dₜₜ and dₛₒ are the tooth tip and slot opening depths in mm. In this study, dₜₜ=dₛₒ for simplicity, but in a practical design scenario, allowing dₜₜ≠dₛₒ does not affect the design guidelines if the tooth tips do not significantly saturate. The tooth tip depth is a measurement of the tooth tip extending away from an edge of the tooth (e.g., a bottom edge of the tooth region 406/506/606) toward the rotor core and/or permanent magnets to a tooth tip end (e.g., a bottom edge of the region 501/601), where the tooth tip has a greater width than the tooth width. The slot opening has a width extending between respective adjacent tooth tips.

FEA results included at the end of this disclosure confirm these conclusions apply to cases where dₜ≠dₛ and dₜₜ≠dₛₒ by varying the “tooth tip angle, θₜₜ” illustrated in FIG. 6. Finally, dₜ, dₛ, and d_{c} are the stator tooth, slot, and core depths, respectively, while dₘ is the magnet depth in mm. As with dₜₜ and dₛₒ, the case study here assumes dₜ=dₛ for simplicity, but similar conclusions still apply if dₜ≠dₛ.

In general, two methods may be used for predicting stator slotting effects for airgap flux density without using finite element analysis (FEA). The first uses the path permeance and flux modulation principles to deterministically calculate airgap flux density as a function of rotor angle. However, this method assumes flux follows predefined paths with constant permeability throughout the rotor and stator steel. Therefore, this approach cannot take saturation into account. The second uses a magnetic equivalent circuit (MEC) to calculate airgap flux density in a wide variety of motor topologies. If using an Iterative numerical solver with enough MEC elements, this method can take saturation and complex geometries into account.

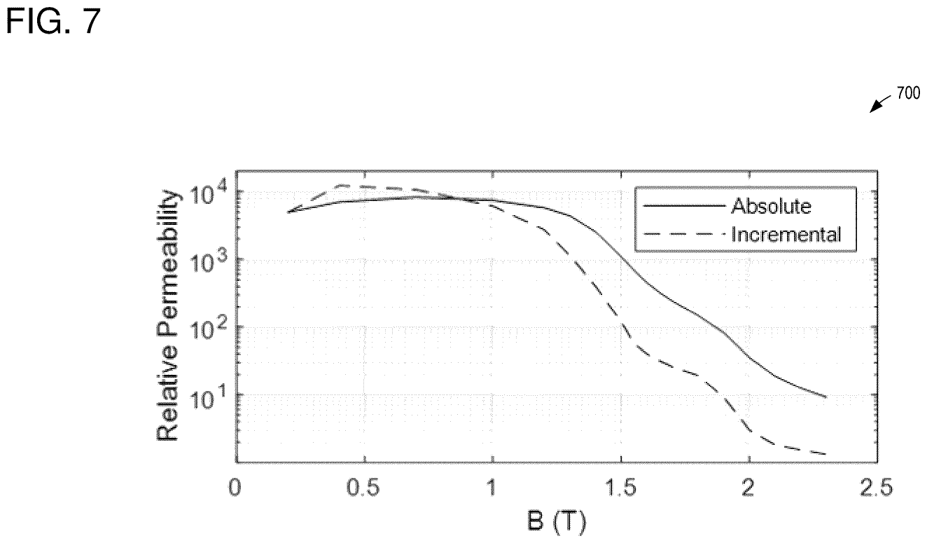

FIG. 7 shows a plot 700 of the absolute (1/μ₀·B/H) and incremental (1/μ₀·dB/dH) relative permeability for M19, a typical electrical steel used in electric machines. Torque dense PMSMs often operate with a peak stator tooth flux density of about 1.5-2 T, deep into saturation with the relative permeability orders of magnitude less than the maximum possible value in FIG. 7. MnBi PMSMs follow this trend, so this disclosure uses the MEC approach to calculate airgap flux density. However, while the path permeance approach may not be as accurate as an MEC in these situations, the results using path permeance approaches still can provide useful intuition for understanding the spatial distribution of air gap flux densities in PMSMs. As described above, incorporating methodologies (e.g., MECs, ROMs, FEA, and/or combinations thereof) that allow integration of the spatial variation in flux and the impacts on local PM demagnetization enable the disclosed approaches to identify trends that show design guidelines, targets, and/or limits for a selected motor topology.

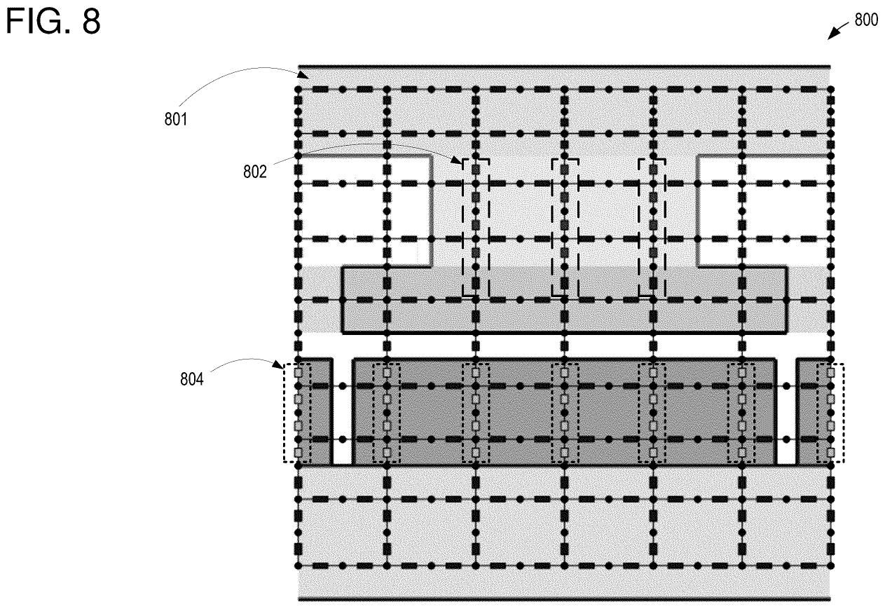

The MEC used here is based on example modeling methods. First, the motor geometry is divided into a gridded mesh of reluctance elements, MMF sources, and flux sources as shown in the MEC 800 over one slot pitch of FIG. 8. Each node of the mesh has a branch inward and outward radially (e.g., vertically in FIG. 8) as well as branches leftward and rightward circumferentially (e.g., horizontally in FIG. 8). The boxes in each branch of FIG. 8 include different circuit elements depending on color/location. Boxes are simply reluctance elements with lengths and cross-sectional areas determined by the motor geometry and the number of MEC elements. Steel regions in FIG. 8 (e.g., shown at 801, including tooth and tooth tips) use the saturable permeability of M19 steel shown in FIG. 7, but all other regions are approximated with constant, free space permeability (e.g., including the PM regions). Therefore, results will differ for PM materials with permeabilities much greater than that of free space. All tooth region (802) and magnet region (804) branches also have reluctance elements as in the remaining branches, but the tooth region branches 802 also have an MMF source in series with the reluctance, representing the winding MMF (e.g., the vertical stator tooth branches), while the magnet region branches 804 have a flux source in parallel, representing the PM Bᵣ (e.g., the vertical magnet branches). After creating the MEC, a nonlinear numerical solver is used to solve the mesh network while considering saturation.

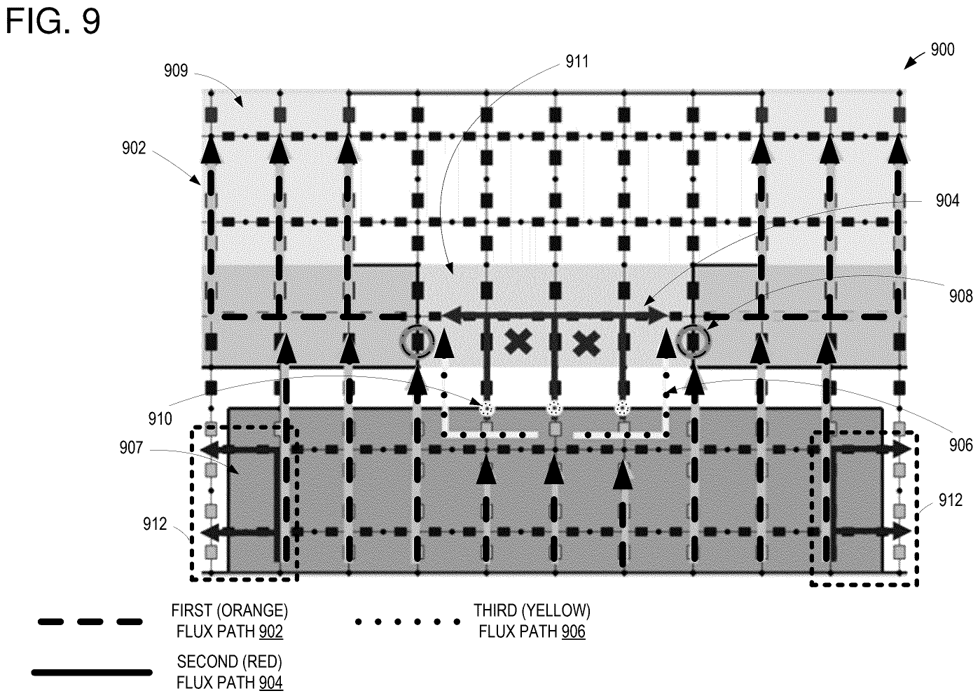

FIG. 9 shows a representative MEC 900 that includes annotations to the MEC in FIG. 8 with certain key flux paths to better understand the impact of slot effects and magnet leakage flux on the air gap flux density distribution. First regarding slot effects, consider the first flux path 902, the second flux path 904, and the third flux path 906. In this orientation, flux is flowing from the rotor to the stator through the magnet. Assuming negligible saturation, the lowest reluctance path for the regions below the stator teeth (e.g., first flux path arrows starting in the magnet region 907 and pointing vertically towards the tooth region 909) is to simply travel vertically from the magnet to the tooth through the air gap and tooth tips. However, flux lines below the slot opening (e.g., first flux path arrows starting in the magnet region 907 and pointing towards the slot region 911) follow a different trend. The second flux paths have a higher reluctance than the third flux paths because the tooth tip reluctance elements circled at 908 have a much lower reluctance than the elements adjacent to the X's in the slot opening. Therefore, more flux will follow the third flux paths than the second flux paths, leading to a decrease in flux density at the nodes circled at 910 (e.g., the portion of the PM surface below the slot opening). PMs with higher permeability than free space permeability may slightly enhance this effect.

On the other hand, the magnet leakage flux paths are represented by arrows in the box 912 to the left and right of the magnet region 907. While most of the flux at the magnet edges will follow the first flux paths because the low reluctance stator teeth, a small amount of flux will leak from magnet to magnet through the flux paths in box 912 without ever crossing the airgap nor entering the stator teeth and stator core. This leads to a decrease in flux density at the magnet corners compared to the middle of the magnets. In this case, PMs with higher permeability than free space permeability will dimmish this effect. Because both the slotting effects and magnet flux leakage decrease the flux density in small portions of the magnet, subsequent results will show that these effects combine such that the highest risk of demagnetization will occur when the magnet corners are near the slot openings.

TABLE I
Design Specifications for MnBi SPMSM Temperature
Dependent Irreversible Demagnetization Case Study

| | | |
|---|---|---|
| | MEC | FEA |
| Variable | Value | Range |

| | |
|---|---|
| Stator OD, Dₛₒ | 135 mm |
| Stator Length, Lₛ | 30 mm |
| Stator Current, Iₛ | 33 A |
| PM Temperature, T_{PM} | 0° C. |
| DC Link Voltage, V_{DC} | 100 V |
| Maximum Torque, Tₑ | 3 Nm |
| Maximum Power, Pₑ | 1 kW |
| Base Speed, ω_{B} | 2000 RPM |
| Maximum Speed, | 8000 RPM |
| ω_{MAX} | |

| | | |
|---|---|---|
| Magnet Width Ratio, | 0.95 | 0.9-1 |
| wₘ | | |
| Magnet Reduction, mᵣ | N/A | 0-0.5 |
| Magnet Depth, dₘ | 13.6 mm | 5-20 mm |

| | |
|---|---|
| Slot Opening Width | 0.1-0.5 |

| | | |
|---|---|---|
| Ratio, wₛₒ/wₛ | | |
| Slot Depth Ratio, dₛ/ | 0.7585 | 0.6-0.8 |
| (dₛ + dₛₒ + d_{c}) | | |
| Tooth Width Ratio, wₜ | 0.5 | 0.1-0.5 |
| Air Gap, g | 0.59 mm | 0.4-0.8 |
| Tooth Tip Angle, θₜₜ | 0° | 1.4-10° |
| Tooth Tip Depth, dₜₜ | 2 mm | 0.5-5 mm |
| Ratio of Stator ID and | 0.6782 | 0.667-0.733 |
| OD, λ | | |

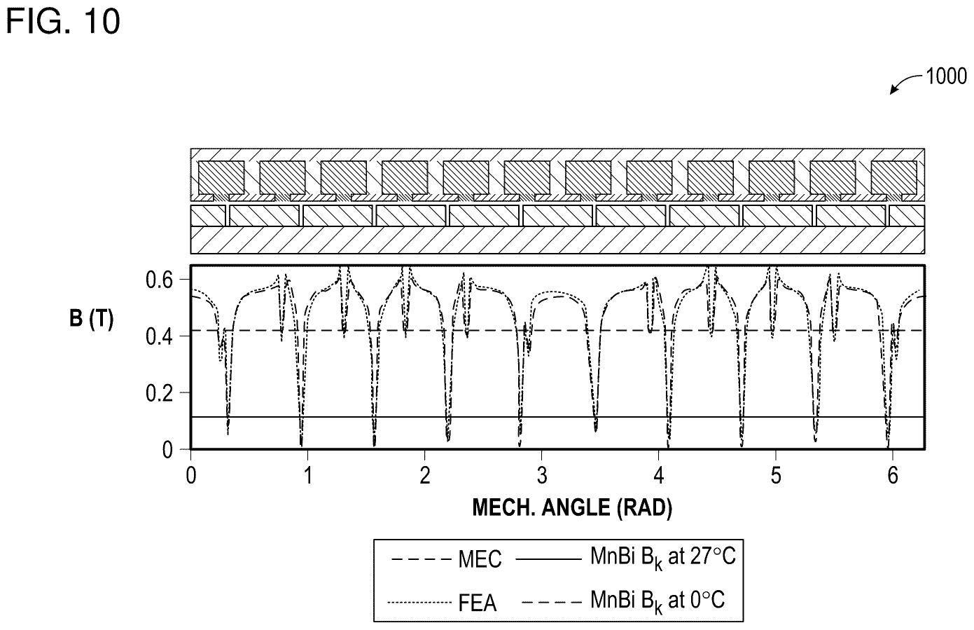

FIG. 10 is a plot 1000 that compares the component of air gap flux density calculated by this MEC and FEA for an example design shown in Table I. Specifically, it shows the component of the air gap flux density parallel with the PM magnetization vector because this is the component of the air gap flux density that impacts irreversible demagnetization. The mechanical angle in the shade-coded sketch above the graph corresponds to the same mechanical angle as in the plot, and the geometry in the drawing is a scaled version of the geometry used to produce the plots in FIG. 10. This design uses radial PM magnetization, and air gap flux density is calculated at open circuit to avoid saturation. All MEC and FEA designs here use the parameters in Table I unless specified otherwise. As expected, peak air gap flux density in FIG. 10 is approximately equal to the remnant flux density of MnBi at the temperature reported in Table I.

To illustrate the low temperature irreversible demagnetization risk, FIG. 10 also includes the values of Bₖ at 0° C. and 27° C. (e.g., as explained in FIG. 1 and as calculated in FIG. 2). The portions of the PM with a flux density less than Bₖ in FIG. 10 and throughout the rest of this work irreversibly demagnetize partially. Here, both the MEC and FEA predict that the PM flux density is always greater than MnBi Bₖ at 27° C. but sometimes less than MnBi Bₖ at 0° C., thus avoiding irreversible demagnetization at 27° C. but suffering partial irreversible demagnetization at 0° C.

FIG. 10 also demonstrates both effects illustrated in FIG. 9. PM flux density is highest in the middle of each magnet and lowest at the edges, showing the effect of leakage flux traveling from magnet to magnet in the paths in box 912 of FIG. 9. It also shows the dips in air gap flux density due to slotting effects, as predicted by the second and third flux paths of FIG. 9. Furthermore, the lowest flux density occurs at the rotor poles centered around 0 rad and π rad because corners of these poles' magnets are adjacent to the slot openings. This leads to greatest risk of irreversible demagnetization at the corners of the PMs adjacent to the slot opening.

### III. Tooth Design to Mitigate Demagnetization in RE-Free and RE-Lean PMSMs

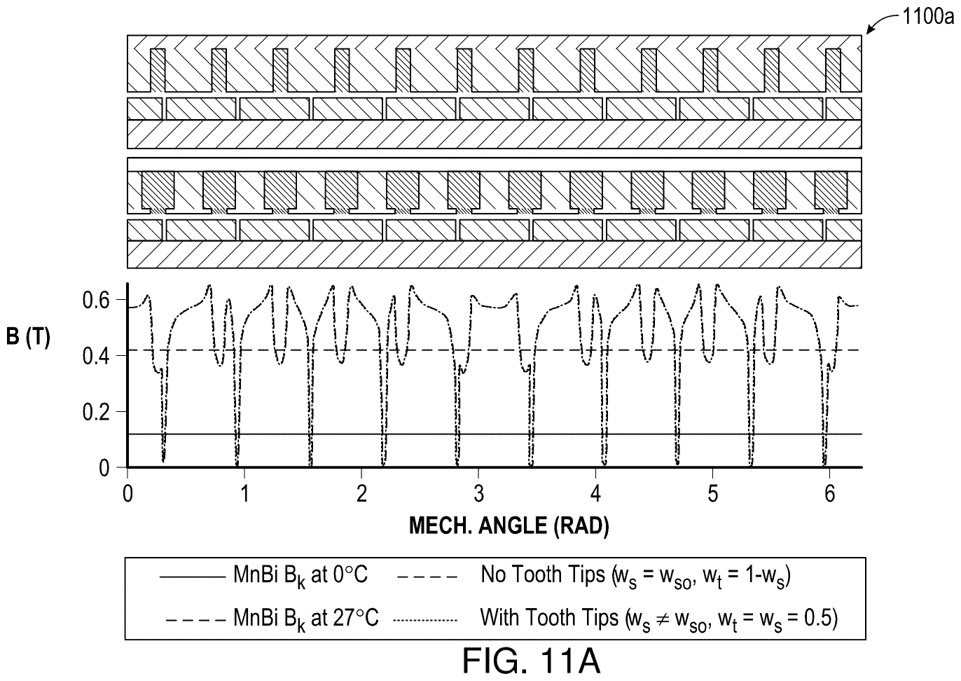

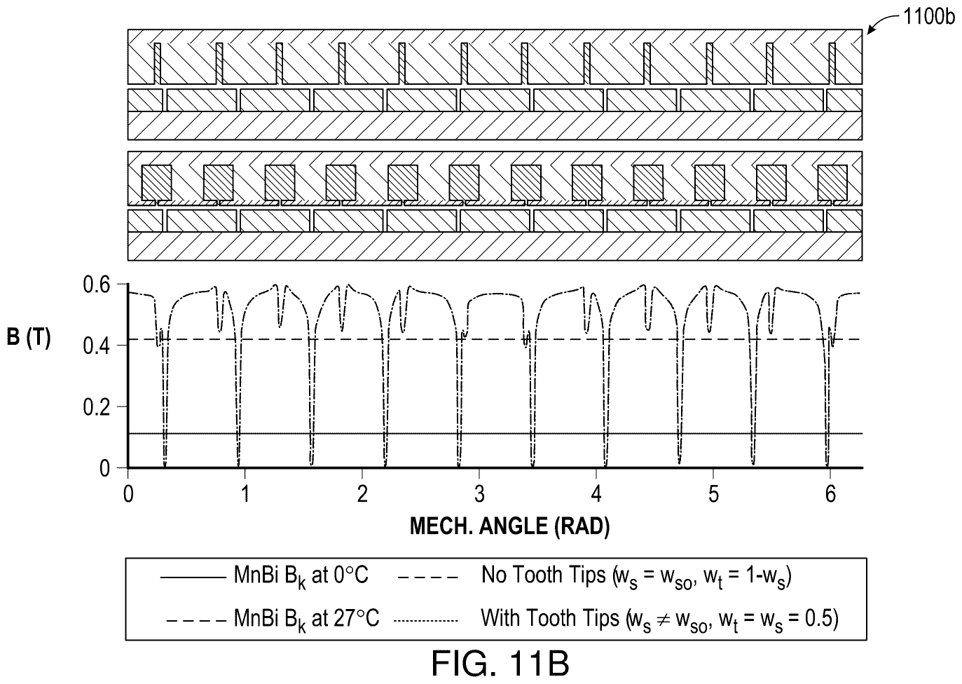

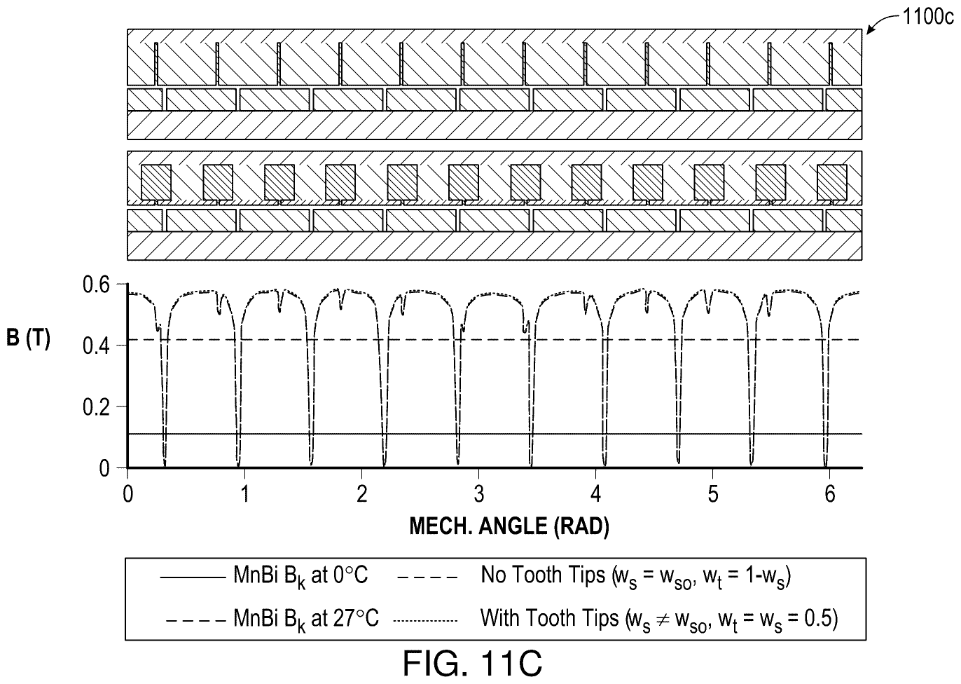

The slotting effect in the air gap flux density due to the geometry in FIG. 4 is well understood if assuming no saturation. FIGS. 11A-11C show plots 1100a, 1100b, and 1100c, respectively, comparing air gap flux density in configurations with thick teeth and no teeth tips to configurations with equal slot and tooth width but large teeth tips for wₛₒ=0.25 (FIG. 11A), wₛₒ=0.1 (FIG. 11B), and wₛₒ=0.05 (FIG. 11C). The dashed lines in FIGS. 11A-11C show an example of the air gap flux density at the PM surface for different tooth' thicknesses, wₜ, using the geometry in FIG. 4. Here, the air gap flux concentrates near the teeth and away from the slots, so thinner teeth result in more significant dips in air gap flux density at the PM surface. Drawings of the motor are again included to illustrate where the stator teeth are located with respect to the mechanical angle in the plots, similar to FIG. 10. RE-free PMSMs may use thinner teeth to maximize torque density by leveraging the tradeoff between electric and magnetic loading. Generally larger slots maximize electric loading due to current density constraints but larger teeth maximize magnetic loading due to saturation constraints.

However, RE-free PMs also tend to have a lower Bₖ, as shown in FIG. 2, and thinner teeth increase demagnetization risk by enhancing the slotting effect discussed earlier, as shown in FIG. 11. Therefore, a tradeoff exists between minimizing demagnetization risk and maximizing torque density in RE-free PMSMs if using the geometry in FIG. 4, without tooth tips. In designs constrained to avoid demagnetization, these design principles of making the effective flux more uniform can actually improve performance (torque, efficiency, etc.) relative to other designs due to the reduced effective gap size and more uniform field within the gap, as typically captured using the effective Carter Coefficient. The plots in FIGS. 11A-11C are also calculated at open circuit, suggesting the designs in FIGS. 11A and 11B suffer from “self-demagnetization” (e.g., irreversibly demagnetizing without current in the stator windings due to nonuniform PM flux density).

The tooth tips in FIG. 5 may also modulate the airgap flux distribution, effecting the demagnetization risk. To investigate this in more detail, the dotted lines FIG. 10 represent MEC designs with wₛₒ equal as their corresponding dashed line, but now with wₜ=wₛ=0.5, a more conventional value for machine design. As in FIG. 10, sketches of the motor geometry are included for all designs in FIGS. 11A-11C. Here, it is shown that the airgap flux density distribution is nearly identical between designs with equal wₛₒ regardless of tooth width. Thus, FIGS. 11A-11C suggests that the tooth tip geometry primarily dictates the severity of air gap modulation due to slotting effects, allowing for much thinner stator teeth in RE-free machines. “Slotless” motors and motors with magnetic wedges have been shown to also weaken airgap flux density modulation due to slotting effects.

Consequently, using small slot openings (sometimes called “semi-closed” slots) can mitigate low temperature irreversible demagnetization risk in MnBi SPMSMs without leading to low electric loading. Similar conclusions may apply to the slotless motor and motors with magnetic wedges, described herein though not shown in FIGS. 11A-11C. Low electric loading is known to degrade torque density RE-free PMSMs with lower Bᵣ. However, subsequent results will show this only holds true if the teeth tips are deep enough (e.g., sufficiently large dₜₜ) to prevent significantly saturating the teeth. In FIGS. 11A-11C, the peak flux density is about 0.6 T with M19 as the core material, well below the saturation levels reported in FIG. 7.

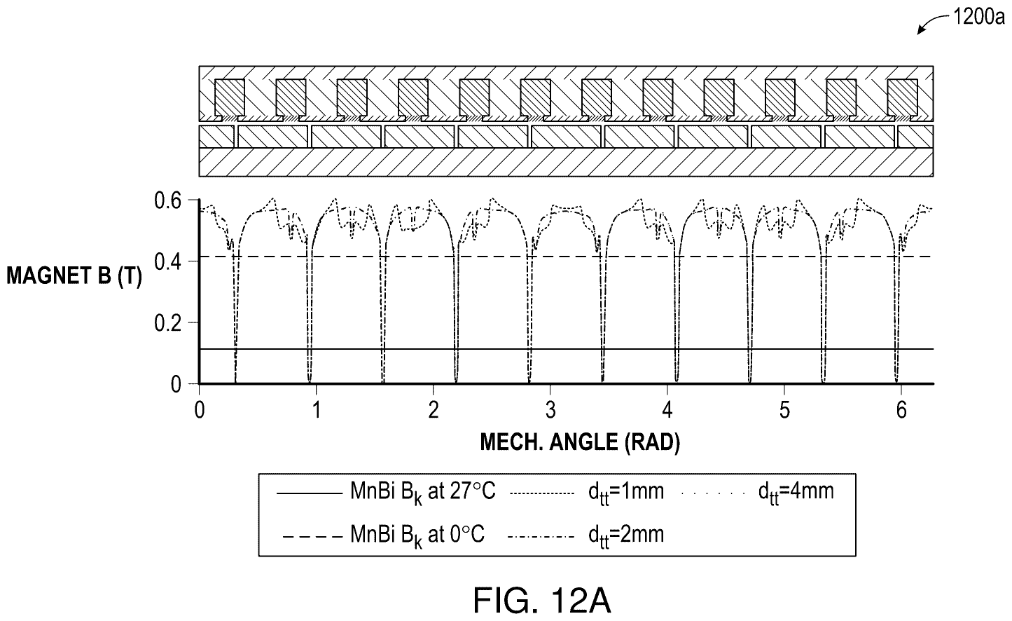

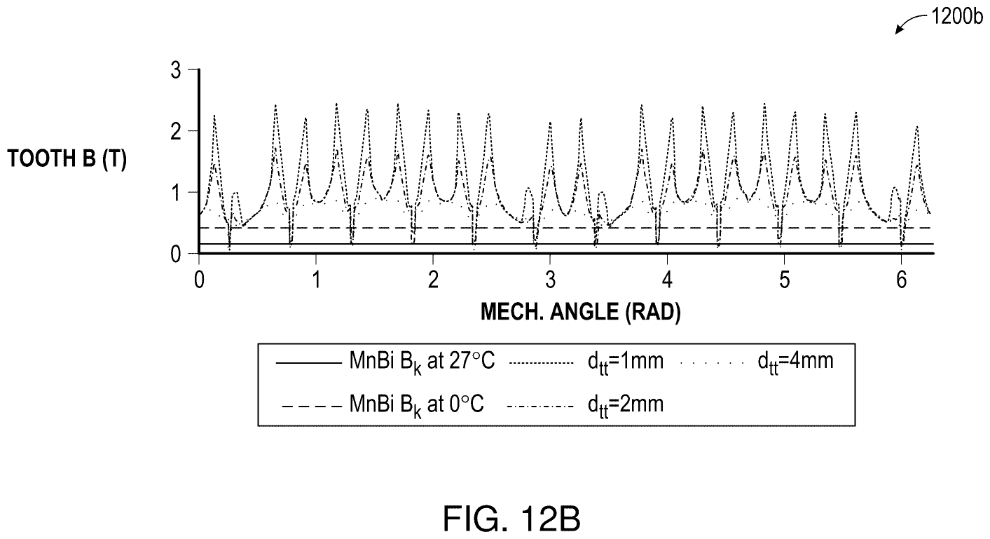

While wide tooth tips can potentially reduce risk of irreversible demagnetization due to slotting effects, FIGS. 12A and 12B illustrate plots 1200a and 1200b, respectively, that show that saturation limits the effectiveness of this solution. For flux densities common in torque-dense, state-of-the-art electric machines (e.g., 1.5-2 T), teeth tips can quickly transition between the relative permeabilities of electrical steel and air due to saturation (see FIG. 3), so the air gap flux density distribution begins to resemble those typical of designs with larger wₛₒ (as seen by comparing FIGS. 11A-11C and FIGS. 12A and 12B). Furthermore, advanced machine design procedures may consider that saturation and size of the tooth tips also affect other aspects of motor performance, such as efficiency (e.g., due to changing core loss) and constant power speed ratio (e.g., due to changing leakage permeance). The motor drawing in FIGS. 11A-11C has dₜₜ=2 mm. It was found that a dₜₜ>2 mm, or in some examples a dₜₜ≥3 mm, resulted in desired self-demagnetization prevention. In additional or alternative examples, a tooth tip depth may be selected as a ratio, such as a ratio of tooth tip depth to air gap thickness, to result in the desired self-demagnetization prevention. For example, a tooth tip depth to air gap thickness ratio (e.g., “a tooth tip depth ratio”) may be selected to be greater than or equal to 0.625 for a 0.8 mm air gap length, less than or equal to 12.5 for a 0.4 mm air gap length, between 0.625 and 12.5 (e.g., for an air gap length between 0.4 mm and 0.8 mm in some examples), between 0.5 and 15 (e.g., for an air gap length between 0.1 mm and 1 mm in some examples), at least 0.625, and/or at least 12.5. Any or all of the ranges of tooth tip depth (or tooth tip depth ratio) described above provides an advantage of reducing or eliminating irreversible demagnetization of permanent magnets in the motor.

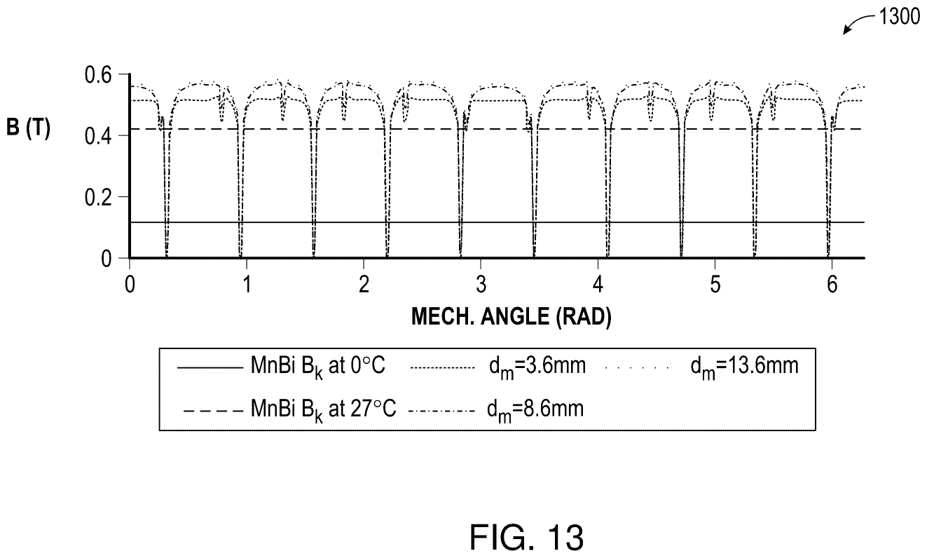

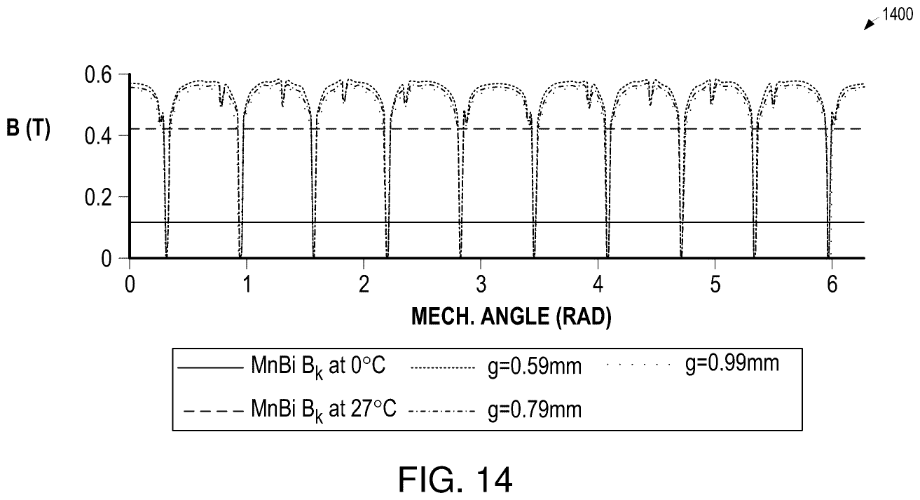

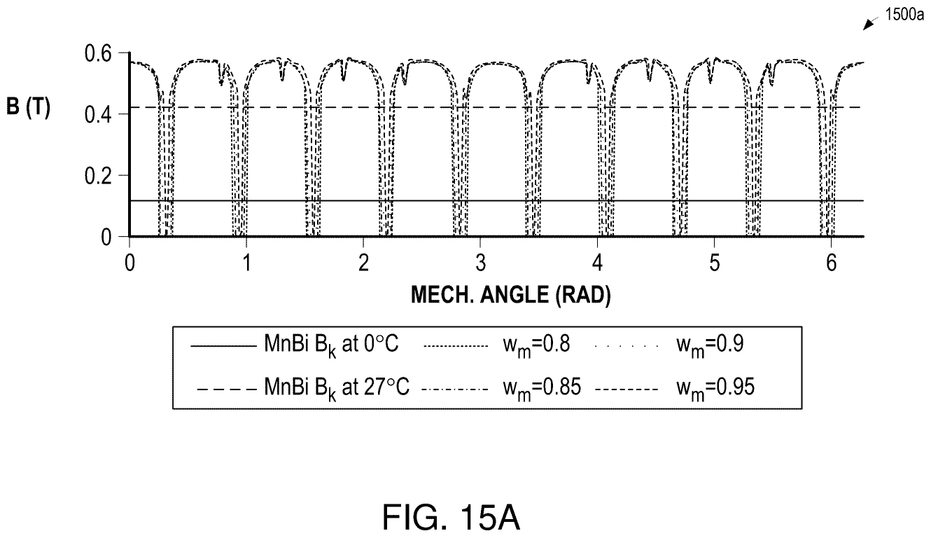

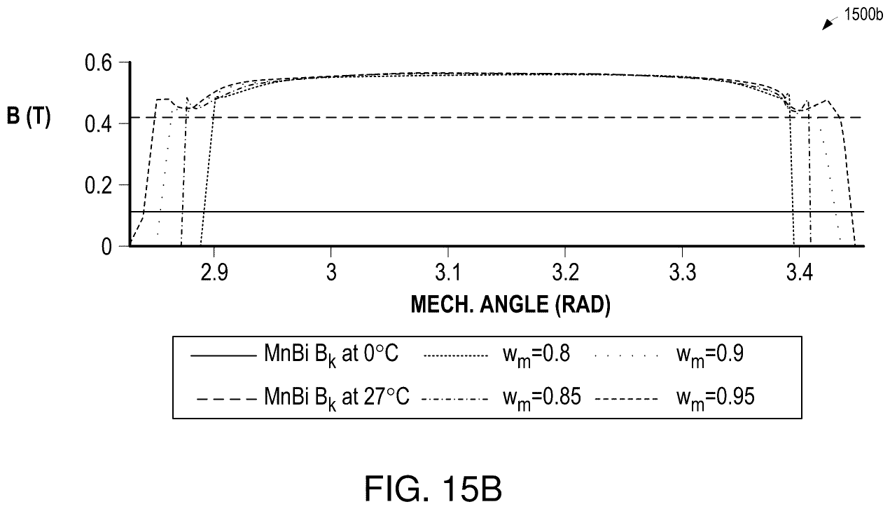

While the air gap flux density modulation effects discussed here certainly have a major impact on demagnetization risk, many other geometric variables have more minor impacts as well. For example, the magnet depth dₘ, air gap length g, and magnet width wₘ all impact the operating point of the permanent magnet, as demonstrated with MECs in plots 1300, 1400, 1500a, and 1500b of FIGS. 13, 14, 15A, and 15B, respectively. For example, plot 1300 of FIG. 13 shows the effect of magnet depth on self-demagnetization, plot 1400 of FIG. 14 shows the effect of air gap length on self-demagnetization, plot 1500a of FIG. 15A shows the effect of magnet width on self-demagnetization for all rotor poles, and plot 1500b of FIG. 15B shows the effect of magnet width on self-demagnetization for rotor poles with the greatest risk of demagnetization. However, other constraints impact these dimensions as well. Manufacturing constraints limit dₘ and g, while maximizing magnetic loading generally demands the highest wₘ possible despite increasing demagnetization risk in FIGS. 15A and 15B. Therefore, optimizing the tooth tip geometry can be a powerful tool for significantly reducing demagnetization risk in RE-free PMSMs, particularly in MnBi SPMSMs. More extensive FEA results in Section IV will corroborate this point.

### IV. Validating Effect of Tooth Configuration Using FEA

Because MnBi has an exceptional property where H_{c} significantly decreases as temperature decreases, MnBi Bₖ decreases significantly at lower temperatures, leading to a significant increase in risk of self-demagnetization. While a similar phenomenon exists for ferrite PMs, its effect on Bₖ is much less significant than in MnBi PMs. Therefore, the impact of this phenomenon on overall SPMSM torque density and efficiency has yet to be studied rigorously. Still, saturation effects make a universal, analytical, closed-form solution unlikely. Therefore, this section analyzes the effect of tooth tip geometries on demagnetization via an FEA sensitivity study. The case study focuses on the impact in MnBi SPMSMs configurations, but the methodology and general trends apply to many other designs susceptible to temperature-dependent irreversible demagnetization, including an RE IPMSM, RE-lean IPMSM, and RE-free ferrite SPMSMs as examples.

According to predictions in Section III, a range of tooth and tooth tip configurations exist which sufficiently limit irreversible demagnetization risk. These configurations all have some combination of wide stator teeth (e.g., narrow slots), wide tooth tips (e.g., narrow slot openings), and deep tooth tips (to avoid saturation). Nonlinearities due to saturation make it difficult to determine exact ranges for these dimensions analytically, but a statistical approach can readily elucidate these ranges. Furthermore, these statistical analyses can naturally consider other tradeoffs in tooth design besides demagnetization, such as efficiency as CPSR. This approach may be used for considering temperature dependent irreversible demagnetization in a traction MnBi IPMSMs multi-objective optimization. A similar approach is used to analyze the impact on irreversible demagnetization for the design space in Table I. This sensitivity study uses 1000 sample designs simulated in FEA, and all designs here use parallel magnetization and magnet geometry.

TABLE II
Design Variables that Most Impact Irreversible
Demagnetization Risk in MnBi SPMSM Case Study

| | DR | Possible | Possible |
|---|---|---|---|
| Variable | COP | DR = 0 | DR <0.1% |
| Magnet Depth, dₘ | 69% | 8.49-20 mm | 7.015-20 mm |
| Tooth Width Ratio, wₜ | 44% | 0.22-0.5 | 0.1126-0.5 |
| Slot Opening Width Ratio, | 32% | 0.1-0.1586 | 0.1-0.2350 |
| wₛₒ/wₛ | | | |
| Magnet Width Ratio, wₘ | 10% | Entire Range | Entire Range |
| Tooth Tip Angle, θₜₜ | 6% | Entire Range | Entire Range |
| Air Gap Length, g | 3% | Entire Range | Entire Range |
| All Others | 0% | Entire Range | Entire Range |

The demagnetization ratio (DR) is calculated in FEA as the ratio of PM finite elements that irreversibly demagnetizes to the total number of PM finite elements in the model. The sensitivity study identifies the parameters discussed above (tooth width wₜ and slot opening width ratio wₛₒ/wₛ) as two of the three variables in Table I with the greatest statistical impact on DR variability, quantified by the coefficient of prognosis (COP). The COP estimates DR accuracy by comparing DR model prediction error to DR variability over the range of each input. As a result, note that the ranges used for the inputs significantly affect the COP. Still, Table II list the inputs with nonzero DR COPs for the design space in Table I. It also lists each variable's COP and the ranges that lead to DR=0% and DR<0.1%. DR is calculated at the PM temperature specified in Table I with the stator current Is in phase with the back EMF. The total DR COP is 93%, which assesses overall model accuracy by comparing DR model prediction error to DR variability over the entire design space in Table I. Table II shows example ranges of variables that may be used to reduce or eliminate irreversible demagnetization. For example, magnet depth may be between 1 mm and 50 mm, between 5 mm and 30 mm, at least 7 mm, between 7 mm and 25 mm, between 7.015 mm and 20 mm, between 7.015 mm and 10 mm, between 7.015 mm and 8.49 mm, between 8.49 mm and 10 mm, between 8.49 mm and 20 mm, at least 7.015 mm, and/or at least 8.49 mm. Expressed in terms of a magnet depth ratio defined as a ratio of magnet depth to air gap length (e.g., for an air gap length of 0.59 mm), the magnet ratio may be between 5 and 50, between 10 and 30, between 13 and 26, between 10 and 25.424, between 13.559 and 30, between 13.559 and 25.424, at least 13, at most 26, at least 13.559, and/or at most 25.424. Any or all of the ranges of magnet depth (or magnet depth ratio) described above provides an advantage of reducing or eliminating irreversible demagnetization of permanent magnets in the motor. A tooth width ratio may be at least 0.1, between 0.05 and 0.75, between 0.1 and 0.75, between 0.1 and 1, between 0.1126 and 0.5, between 0.1126 and 0.22, between 0.22 and 0.5, between 0.22 and 0.75, between 0.22 and 1, at least 0.1126, and/or at least 0.22. Any or all of the ranges of tooth width ratio described above provides an advantage of reducing or eliminating irreversible demagnetization of permanent magnets in the motor. A slot opening width ratio may be below 0.25, between 0.001 and 0.5, between 0.01 and 0.25, between 0.01 and 0.2350, between 0.1 and 0.2350, between 0 and 0.1586, between 0.01 and 0.1586, between 0.1 and 0.1586, between 0.01 and 0.2, between 0.1 and 0.18, between 0.1586 and 0.2350, between 0 and 0.2350, less than or equal to 0.2350, and/or less than or equal to 0.1586. Any or all of the ranges of slot opening width ratios described above provides an advantage of reducing or eliminating irreversible demagnetization of permanent magnets in the motor. Again, the findings from Table II would apply to other RE and RE-free motor designs, although the exact COP and ranges would vary depending on the exact PM material, operating temperatures, and motor topology. The MnBi SPMSM is used as a case study here because temperature-dependent demagnetization significantly impacts the electromagnetic performance of the motor. Although the slot opening is greater than 0 for all designs in this study (i.e., using only semi-closed slots), similar conclusions extend to slotless motors and motors with magnetic wedges.

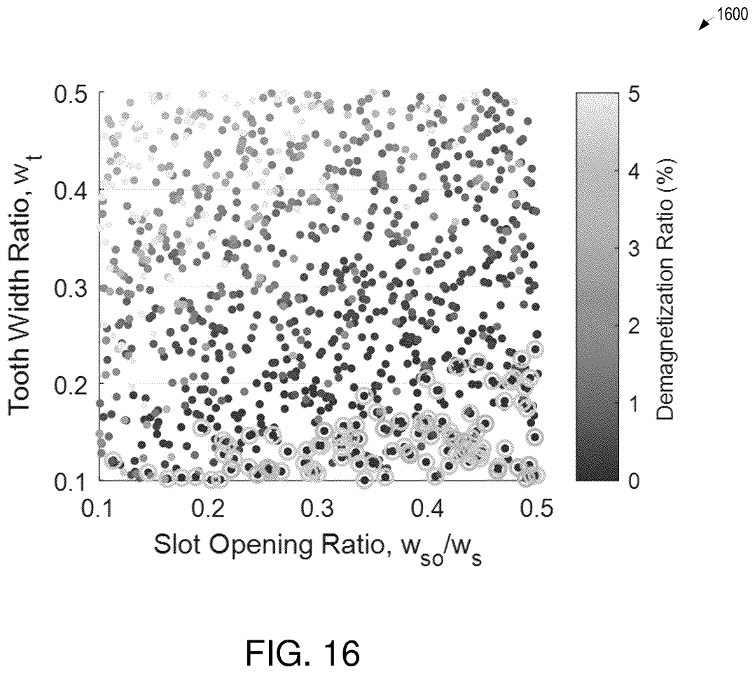

FIG. 16 shows a scatter plot 1600 of DR with respect to wₜ and the ratio of slot width opening wₛₒ to slot width wₛ for all configurations in the sensitivity study. To illustrate the ranges in Table II, dots that are circled represent designs where DR=0 or where DR≤0.1%. As suggested in Section III, there exists a range of acceptable combinations of wₜ (and wₛ) so long as wₛₒ remains small. However, the ranges in Table II are only approximate due to the statistical approach used here. Iteratively refining the input ranges can improve the precision of the boundary between reversible and irreversible demagnetization. It also shows that satisfying all the ranges specified in Table II does not necessarily guarantee demagnetization-free operation under the conditions in Table I. This is true because many other inputs also affect irreversible demagnetization, just to less significant degree than the inputs and ranges in Table I.

As discussed in Section III, other geometric variables impact demagnetization risk as well. The sensitivity study identifies magnet thickness as another critical variable, for example. The magnet thickness lower bound exists because it decreases the magnetic field at the PM operating point at peak current, thus moving the peak operating point away from Bₖ. The upper bound in Table II is simply the upper bound of the input range in Table I. However, more practical upper bounds exist depending on the PM material primarily due to manufacturing constraints, but also due to PM leakage effects shown in FIG. 8 and discussed in Section II.

### V. Additional Examples—Wedges

As described above, the technologies described herein may be utilized in configurations that include motors with magnetic wedges. For example, magnetic wedges as described herein may be positioned in the slots described above (e.g., stator slots 408, 508, and 608 in FIGS. 4-6). Notable specifications for electric propulsion systems are torque, efficiency, and constant power speed range (CPSR). Axial flux permanent magnet (AFPM) machines suitable for applications that benefit from compact design and high-power density are difficult to manufacture and assemble compared to radial flux permanent magnet (RFPM) machines. The effects of stator semi-closed slots and magnetic wedges on performance are described herein. The inner stator dual sided rotor and inner rotor dual sided stator geometries discussed herein, which are mainly utilized in electric vehicle systems, were created based on the 3-D finite element analysis (FEA) model. FEA results show that the stator slot design increases output power by 8% in the inner rotor dual sided stator motor and increases efficiency by 8.3% in the inner stator dual sided rotor motor compared to open slots. The results show that semi-closed slots and magnetic wedges have a significant impact on the performance of AFPM machines and are a useful consideration for design optimization.

### 1. Introduction

Designers of electric motors for electric propulsion systems aim to meet the targeted performance with high power density. Motor designers may accurately understand and consider the key features of the motor type considered for the application system and the impact of limited design variables on performance to provide optimal solutions. Axial flux permanent magnet (AFPM) machines are very suitable for applications that require high torque density and have strict limitations on motor axial length. AFPM machines provide an attractive solution for in-wheel direct-drive electric vehicle systems. Compared to radial flux permanent magnet (RFPM) machines, the AFPM machine also requires strict manufacturing and assembly accuracy to prevent electromagnetic force-induced air gap asymmetry between the stator and rotor. Motor manufacturing costs have remained relatively high because the manufacturing tolerances of major components must be precisely controlled. Open slots that allow for easy assembly of flat ribbons or rectangular conductors are often applied to the stator slot design of AFPM machines. However, the slotting effect caused by open slots causes rotor eddy current losses. Fractional-slot concentrated-winding (FSCW), which can increase torque density without increasing motor size by increasing the copper fill factor within a limited slot space to accommodate more current, is widely used. The disadvantage of the FSCW method is that it generates many spatial harmonic components and thus increases rotor loss. These harmonic components also cause increased noise, vibration, unbalanced magnetic forces and torque ripple. Motor designers aim to ensure that electric motors have a wide constant power speed range (CPSR) performance, a specification for use in electric propulsion systems. However, the CPSR of AFPM machines is very limited because of their small synchronous inductance.

Topologies for AFPM machine design can be basically divided into single-sided, inner stator dual sided rotor, inner rotor dual sided stator, and multi-staged structures. It was investigated that the inner stator dual sided rotor geometry with high power density and inner rotor dual sided stator geometry with excellent heat dissipation capability were mainly applied for electric vehicle systems. Inner stator dual sided rotor geometry benefit from a design that minimizes heat loss because it is difficult to dissipate heat because the stator winding is located between the two rotor disks. In the inner rotor dual sided stator geometry, which has lower power density than the inner stator dual sided rotor geometry, a design that can improve power density may be considered. The effect of semi-closed slots or magnetic wedges on rotor losses, cogging torque, and CPSR were analyzed, but not much research has been performed. This disclosure provides guidelines for AFPM machine designers to optimize designs based on stator slot design modifications, considering the characteristics of each topology.

Herein, the influence of semi-closed slots and magnetic wedges on the performance of AFPM machines is investigated compared to stator open slots. The characteristics of FSCW machines with inner stator dual sided rotor geometry and inner rotor dual sided stator geometry, respectively, were analyzed based on 3-D FEA. FEA results show that compared to open slots, semi-closed slots or magnetic wedges provide solutions that reduce permanent magnet (PM) loss and torque ripple by up to 98% and 7.8%, respectively. It was confirmed that the degree of influence, including torque characteristics, varies depending on topology. It is expected to help motor designers understand the impact of semi-closed slots and magnetic wedges on performance and provide optimal designs considering topology, target specifications, manufacturable designs, and cost.

### 2. 3-D Finite Element Modeling

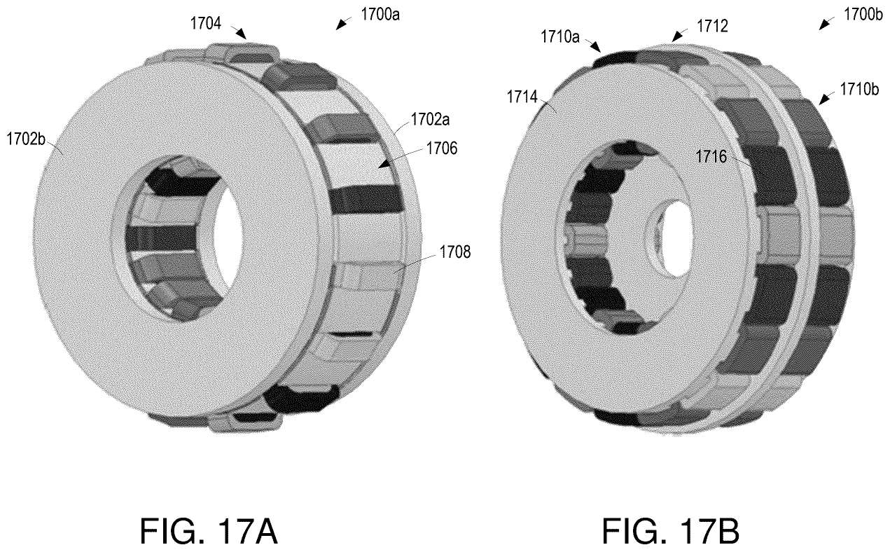

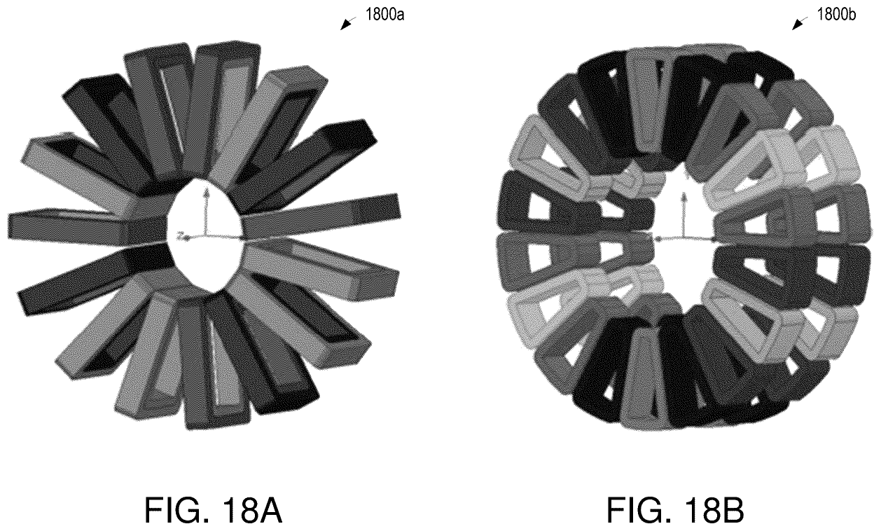

The basic design of the inner stator dual sided rotor motor and inner rotor dual sided stator motor considered in these examples are shown in the below-referenced figures. Table III shows the basic specifications and configuration of the motors 1700a and 1700b shown in FIGS. 17A-17B. Motor 1700a shows an example double-sided rotor configuration including a first rotor 1702a and a second rotor 1702b (e.g., each including a respective rotor back iron/core and a respective permanent magnet(s)), as well as a stator 1704 positioned between (e.g., sandwiched between) the first and second rotors. The stator 1704 includes a plurality of windings 1708 configured to surround or otherwise be positioned around a core 1706 of the stator. Motor 1700b shows an example double-sided stator configuration including a first stator 1710a and a second stator 1710b, with a rotor 1712 (e.g., including a rotor back iron/core and/or permanent magnet(s)) sandwiched or otherwise positioned therebetween. The stators 1710a and 1710b each include a respective stator core (e.g., stator core 1714 of stator 1710a) and windings (e.g., windings 1716 of stator 1710a) configured to surround or otherwise be positioned around respective teeth of the corresponding stator core. A shape of the windings of FIGS. 17B and 17B are shown in more detail in FIGS. 18A and 18B, respectively.

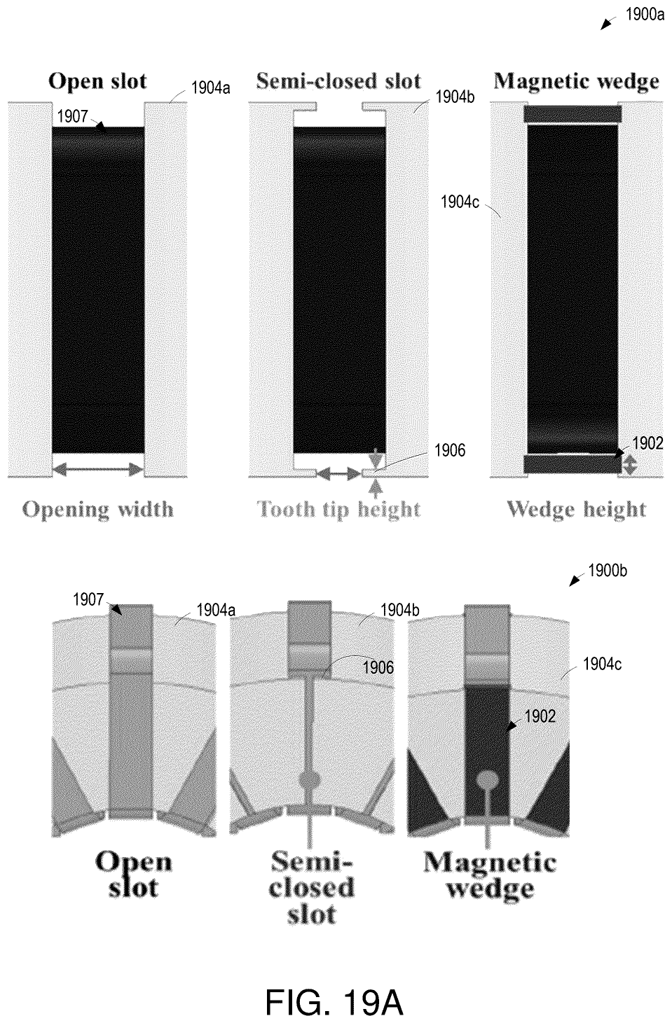

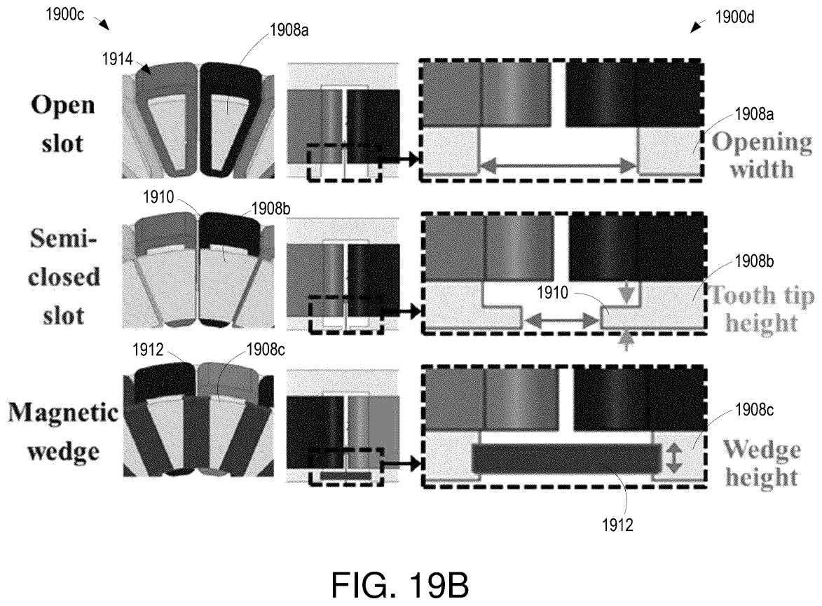

FSCW configurations, which are susceptible to rotor loss, vibration, and torque ripple due to harmonic components but can increase the copper slot fill factor and reduce the end winding length, were applied to both motors. Core-wound coil 1800a and tooth-wound coil 1800b were applied to the inner stator dual sided rotor and inner rotor dual sided stator geometries, respectively, according to the reference models, as shown in FIGS. 18A-18B. For example, core-wound coil 1800a is an example of windings 1708 of FIG. 17A and tooth-wound coil 1800b is an example of windings 1716 of FIG. 17B. Both referenced motors were designed with a stator slot width of 12 mm, however, it is to be understood that the technologies described herein may be applicable to other slot widths (e.g., where components may be selected to have a size that is a targeted ratio relative to the slot width and/or or one or more other parameters in some examples). An open slot with the same opening width as the slot width was applied as a basic design to analyze the effect of stator slot design on motor performance. As the height of the tooth tip or magnetic wedge increases, the copper slot fill factor decreases, and too small a value reduces the mechanical strength. In addition, a minimum slot opening width is provided to insert the coil into the slot. FIGS. 19A and 19B show different perspectives 1900a-1900d of stator slot configurations (e.g., for side view and an isometric view of a double-sided rotor geometry in 1900a and 1900b, respectively, of FIG. 19A and for an isometric view and a side view of a double-sided stator geometry in 1900c and 1900d, respectively, of FIG. 19B), where the stator core (or adjacent teeth of the stator core) is shown at 1904a and 1908a for an open slot configuration in FIGS. 19A and 19B, respectively, at 1904b and 1908b for a semi-closed slot configuration in FIGS. 19A and 19B, respectively, and at 1904c and 1908c for a magnetic wedge configuration in FIGS. 19A and 19B, respectively. As shown, the semi-closed slot includes tooth tips 1906 and 1910 in FIGS. 19A and 19B, respectively, which may be examples of the tooth tips described in more detail above (e.g., with respect to FIGS. 5 and 6). The stator also includes windings as described above with respect to FIGS. 17A-18B (e.g., windings 1907 and 1914 of FIGS. 19A and 19B, respectively).

The 3D FEA models in FIGS. 19A-19B were determined with reference to the tooth tip height, minimum slot opening width, and magnetic wedge height of existing production products with semi-closed slots or magnetic wedges (e.g., magnetic wedge 1902/1912, of FIGS. 19A/19B respectively, having a height as shown that is measured in a direction perpendicular to the opening width of the slot (e.g., the slot width)). The effect of the semi-closed slot was investigated while the tooth tip height was fixed at 1 mm and the opening width was reduced from 12 mm to 8 mm, 4 mm, and 2 mm. However, in other examples, the technologies described herein may be used for motors with other dimensions that achieve the benefits described herein. Soft magnetic composite wedges such as Somaloy have been applied to AFPM machines. In this example, a magnetic wedge made of Somaloy material was used, which has a smaller permeability than the electrical steel sheet applied to the core, but a much greater permeability than a general magnetic wedge containing iron powder dispersed in resin. In other examples, other materials, such as other soft magnetic composites (SMCs), may be used for the magnetic wedge. Depending on the properties of the magnetic wedge material(s), various thicknesses of the wedge may be modified. Overall efficiency, temperature stability, and other parameters may also be a consideration based on characteristics of the wedge material (e.g., loss characteristics, etc.) The influence of the magnetic wedge on motor characteristics was analyzed by changing the height of the magnetic wedge to 1 mm, 1.5 mm, and 2 mm. However, it is to be understood that in other examples, the technologies described herein may be used for motors having magnetic wedges with other dimensions that achieve the benefits described herein. Motor characteristics at no load and rated load under the same input conditions for each topology were obtained through 3-D transient FEA simulation. In addition, the characteristics were compared under 20° C. operating conditions to analyze the influence of design variables under the same conditions.

TABLE III
Basic Specification and Configuration of AFPM Machines

| | Inner stator dual | | Inner rotor dual | |
|---|---|---|---|---|
| Type | sided rotor | | sided stator | |
| Continuous power | 1 | kW | 4 | kW |
| Base speed | 1,800 | rpm | 2,000 | rpm |

| | | |
|---|---|---|
| Slot/pole number | 15 s/4 p | 18 s/16 p |

| | |
|---|---|
| Magnet | NdFeB |
| Core | Electromagnetic steel sheet (M400-50A) |

### 3. Influence of Stator Slot Design on Performance

### A. Torque

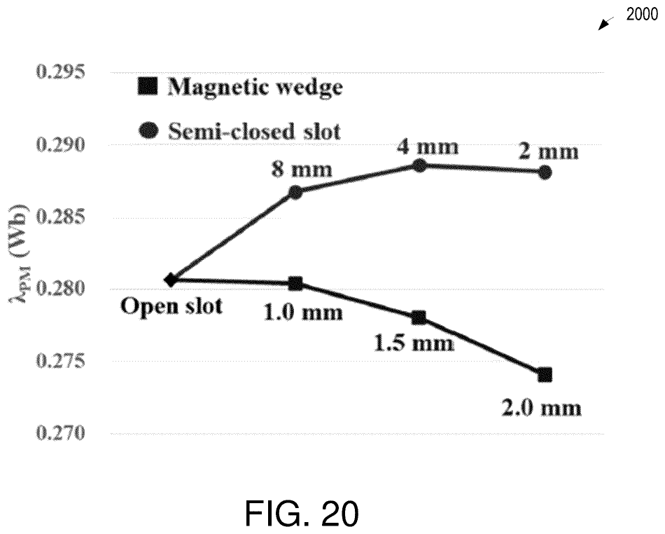

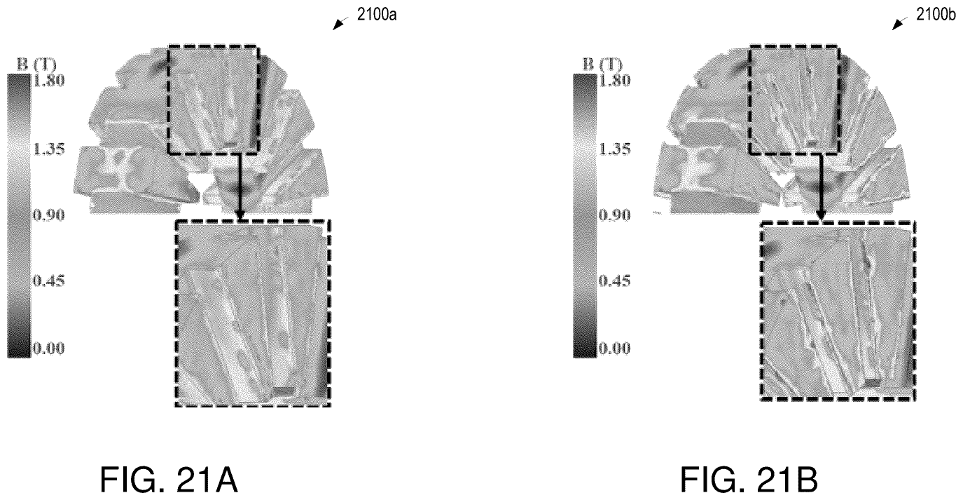

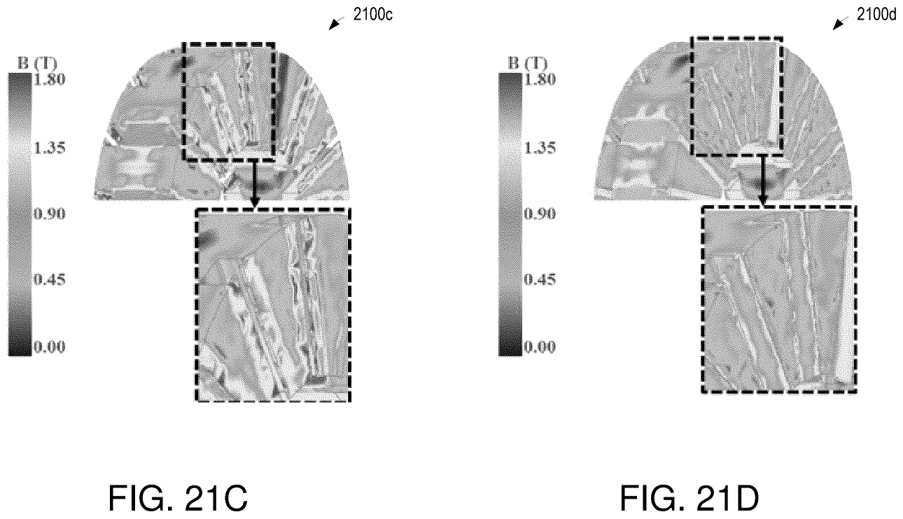

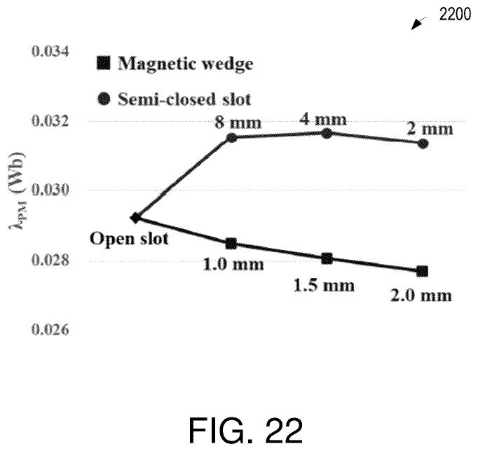

The output power (Pₒᵤₜ) is proportional to the electromagnetic torque (T). The torque of a PM synchronous motor is divided into reluctance torque due to the difference between the d-axis inductance (L_{d}) and q-axis inductance (L_{q}) and magnetic torque due to magnetic flux linkage (λₚₘ). T can be derived

$$T = \frac{{P}_{out}}{{ω}_{r}} = \frac{3}{2} P ( ( {L}_{d} - {L}_{q} ) {i}_{q} {i}_{d} + {λ}_{pm} {i}_{q} ) \qquad ( 1 )$$

where ωᵣ is the mechanical angular speed, P is the number of pole pairs and i_{q} and i_{d} are the stator currents of the q-axis and d-axis. In AFPM machines, the values of L_{d} and L_{q} are almost the same, so T is proportional to λₚₘ. The 3-D FEA results performed on the two machines show that compared to open slots, the value of λₚₘ tends to increase as the slot opening width decreases, while it decreases as the height of the magnetic wedge increases, as shown in plots 2000 and 2200 of FIGS. 20 and 22. It can be shown that the magnetic flux generated by the PM flowed through the magnetic wedge of the stator slot, resulting in a decrease in λₚₘ. As the height of the magnetic wedge increases, more leakage magnetic flux is generated, and the magnetic flux linkage gradually decreases. λₚₘ is proportional to the air gap flux (Φ_{g}) and is obtained from

$${λ}_{pm} = {k}_{w} {N}_{ph} {Φ}_{g} \qquad ( 2 )$$

where k_{w} is the stator winding factor and Nph is the number of series turns per phase. As the slot opening width decreases, the effective air gap length estimated by the Carter coefficient decreases and Φ_{g} increases. Plot 2000 of FIG. 20 and visualizations 2100a-2100c of FIGS. 21A-21C show that as the opening width of the semi-closed slot decreases to 8 mm and 4 mm, the magnetic flux generated by the PM flows through the tooth tip and gradually more magnetic flux links with the stator coil compared to the open slot model. As the opening width decreases further from 4 mm to 2 mm, the slot leakage flux increases through the narrowed slot opening, resulting in a decrease in λₚₘ for both machines. Visualization 2100d of FIG. 21D shows that some magnetic flux flows smoothly through the magnetic wedge and leaks without linking with the stator coil. Tables IV-V obtained from the torque show that Pₒᵤₜ increases significantly to 8% in the inner rotor dual sided stator motor but slightly to 3% in the inner stator dual sided rotor motor through the application of semi-closed slots. Considering that the torque of an AFPM machine is proportional to the third power of the PM or stator core outer diameter, a semi-closed slot design can be an attractive solution for inner rotor dual sided stator topologies that require high power density designs.

TABLE IV
Motor Output Power of Inner Stator Dual Sided Rotor Geometry

| Semi-closed slot | | | Magnetic wedge | | |
|---|---|---|---|---|---|
| Open slot | 12 mm | 1.00 kW | Open slot | 12 mm | 1.00 kW |
| Slot opening | 8 mm | 1.02 kW | Magnetic | 1.0 mm | 1.00 kW |
| width | 4 mm | 1.03 kW | wedge height | 1.5 mm | 0.99 kW |
| | 2 mm | 1.03 kW | | 2.0 mm | 0.98 kW |

TABLE V
Motor Output Power of Inner Rotor Dual Sided Stator Geometry

| Semi-closed slot | | | Magnetic wedge | | |
|---|---|---|---|---|---|
| Open slot | 12 mm | 3.97 kW | Open slot | 12 mm | 3.97 kW |
| Slot opening | 8 mm | 4.28 kW | Magnetic | 1.0 mm | 3.87 kW |
| width | 4 mm | 4.30 kW | wedge height | 1.5 mm | 3.81 kW |
| | 2 mm | 4.26 kW | | 2.0 mm | 3.76 kW |

The d-axis armature reaction reduces the total armature flux linkage and thus controls the induced voltage in the high-speed region. CPSR depends on the characteristic current (I_{ch}), and optimal CPSR can be achieved by closely matching Ich and rated current. I_{ch} is calculated from

$${I}_{ch} = \frac{{λ}_{pm}}{{L}_{d}} \qquad ( 3 )$$

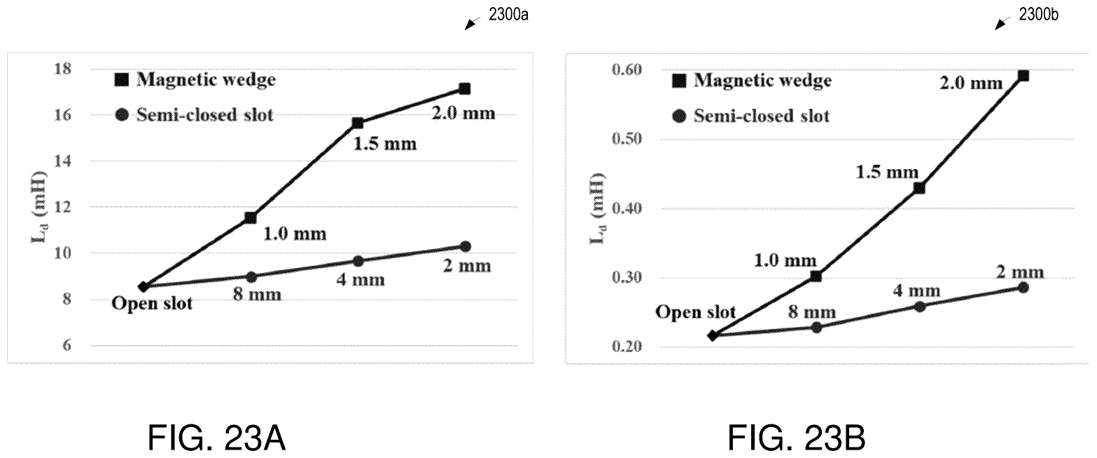

Since the AFPM machine basically has a very small L_{d}, a design to widen CPSR is utilized. The L_{d} values obtained with 3-D FEA in both machines increase as the slot opening width decreases or as the magnetic wedge height increases, as shown in plots 2300a and 2300b of FIGS. 23A-23B. FEA results show that applying magnetic wedges is very effective in increasing L_{d}. L_{d} consists of air gap inductance and stator leakage inductance. As the opening width of the semiclosed slot decreases, the air gap inductance and stator leakage inductance increase. On the other hand, as the height of the magnetic wedge increases, the air gap inductance decreases and the stator leakage inductance increases significantly, leading to an increase in the L_{d} value. The rated current and I_{ch} of the open slot model in the inner rotor dual sided rotor motor have 6.3 A and 33 A, respectively, and 54 A and 135 A in the inner rotor dual sided stator motor. Both motors have very high I_{ch} compared to the rated current due to the small L_{d} of the open slot model. I_{ch} decreases to 28 A in the inner stator dual sided rotor and 110 A in the inner rotor dual sided stator through the semiclosed slot. I_{ch} is greatly reduced to 47 A in the inner stator dual sided rotor and 16 A in the inner rotor dual sided stator due to the reduced λₚₘ and increased La through the magnetic wedge. These results indicate that motor designers can reduce I_{ch} and increase CPSR through semi-closed slots or magnetic wedges.

### B. Efficiency and Torque Ripple

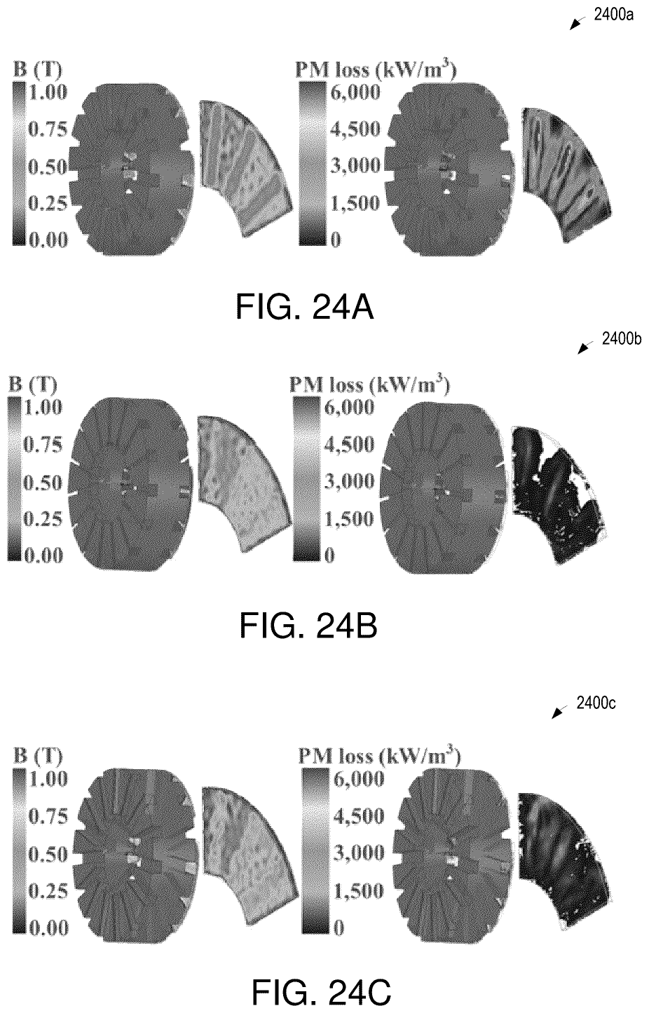

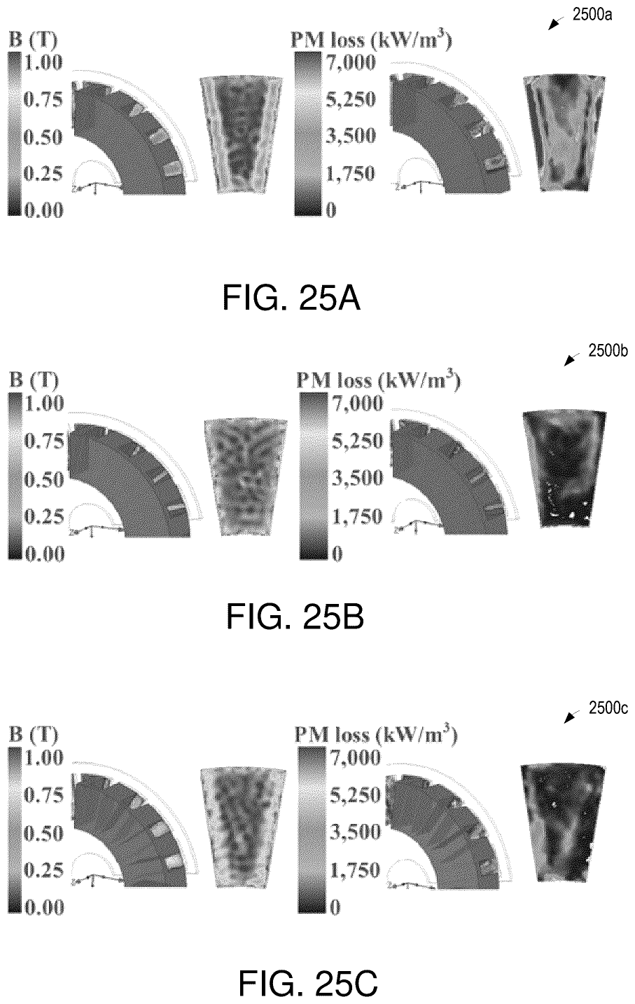

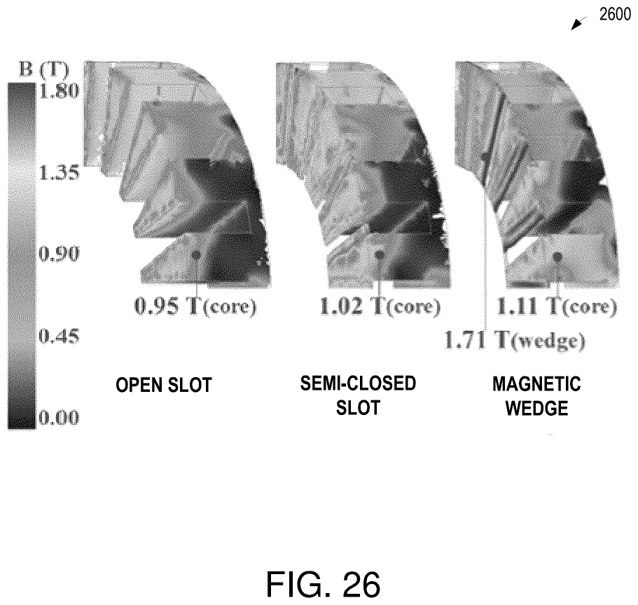

The disclosure provides example designs where the design methodology actually improved performance (efficiency, torque ripple, etc.) in cases where the designs do not undergo demagnetization, due to improved flux uniformity. Losses of AFPM machines can be divided into stator copper loss, PM loss due to eddy current, iron loss, and mechanical loss. The height of the stator winding was kept constant so that the stator copper loss was the same regardless of slot design changes, and the mechanical loss was ignored. Eddy current loss was not considered in the stator winding because the operating frequencies of the inner rotor dual sided rotor and the inner rotor dual sided stator were as low as 60 Hz and 267 Hz, respectively, at the base speed. Eddy current loss in PMs is directly affected by magnetic flux density distribution. The open slot model shows a non-uniform magnetic flux density distribution in PMs as shown in visualizations 2400a and 2500a of FIGS. 24A and 25A, while the magnetic flux density is relatively evenly distributed in the semi-closed slot model and the magnetic wedge model. Visualizations 2400b, 2400c, 2500b, and 2500c of FIGS. 24B-24C and 25B-25C show that the eddy current loss is also significantly reduced along with the uniform magnetic flux density distribution. The core loss increases with the saturated magnetic flux density. The FEA results shown in visualization 2600 of FIG. 26 show that the average magnetic flux density of the stator core increases from 0.95 T with open slots to 1.02 T with semi-closed slots and 1.11 T with magnetic wedges. In the semi-closed slot model, magnetic flux flows through the tooth tip, which has a smaller reluctance than the air gap, resulting in local saturation magnetic flux density. It was analyzed that the magnetic wedge formed a closed circuit through which magnetic flux could flow, and the average magnetic flux density of the wedge increased to 1.71 T, increasing iron loss.

The efficiency according to stator slot modification for each topology obtained through 3-D FEA is calculated as shown in Table VI. The application of semi-closed slots and magnetic wedges in the inner stator dual sided rotor geometry significantly reduces PM losses, resulting in a 56% and 52% reduction in total losses compared to open slots, respectively. As a result, the efficiency improves by 8.3% and 7.6%, respectively. Table VI shows that the electromagnetic torque of the inner rotor dual sided stator topology with two stators and a tooth wound coil is also greatly affected by the modification of the stator slot design. Compared to the open slot model, the output power of the semi-closed slot model increases by 8%, while the output power of the magnetic wedge model decreases by 3%. Models with semi-closed slots or magnetic wedges increase iron loss, but significantly reduce PM loss, resulting in 4.4% and 2.1% improvement in efficiency, respectively.

TABLE VI
Performance of Inner Stator Dual Sided Rotor Motor

| | | | Open | Semi-closed | Magnetic |
|---|---|---|---|---|---|
| Inner stator dual sided rotor | | | slot | slot | wedge |
| Torque ripple | | % | 19.5 | 12.1 | 11.7 |
| Output power | | kW | 1.00 | 1.03 | 0.99 |
| Load Loss | Stator ohmic | W | 21 | | |
| | PM | | 122 | 9 | 20 |
| | Core | | 46 | 54 | 49 |
| | Total | | 189 | 84 | 90 |

| | | | | |
|---|---|---|---|---|
| Efficiency | % | 84.1 | 92.4 | 91.7 |

TABLE VII
Performance of Inner Rotor Dual Sided Stator Motor

| | | | Open | Semi-closed | Magnetic |
|---|---|---|---|---|---|
| Inner stator dual sided rotor | | | slot | slot | wedge |
| Torque ripple | | % | 8.4 | 7.4 | 6.4 |
| Output power | | kW | 3.97 | 4.30 | 3.87 |
| Load Loss | Stator ohmic | W | 44 | | |
| | PM | | 252 | 4 | 6 |
| | Core | | 161 | 187 | 246 |
| | Total | | 457 | 235 | 296 |

| | | | | |
|---|---|---|---|---|
| Efficiency | % | 89.7 | 94.1 | 91.8 |

Fractional slots and concentrated coils generate high harmonic components and therefore high torque ripple. High torque ripple can cause vibrations to accelerate bearing aging and create uneven airgap, which can be particularly fatal for AFPM machines that need to maintain uniform airgap. Semi-closed slots and magnetic wedges reduce the harmonic components of the air gap magnetic flux and distribute the magnetic flux evenly, reducing torque ripple. The torque ripple of the inner rotor dual sided stator machine is reduced from 8.4% to 7.4% and 6.4% with the semi-closed slot and magnetic wedge, respectively, as shown in Table VII. In the inner stator dual sided rotor, Table VI shows that the high torque ripple of 19.5% is reduced by about 7% through semi-closed slots or magnetic wedges.

### 4. Conclusion

The effects of semi-closed slots and magnetic wedges on the performance of AFPM machines were investigated. Torque, key parameters and efficiency characteristics were analyzed based on 3-D FEA in inner stator dual sided rotor and inner rotor dual sided stator topologies. The results show that semi-closed slots and magnetic wedges slightly increase iron loss, but greatly reduce PM loss, contributing significantly to efficiency improvement. Additionally, the slot design reduces torque ripple, indicating that it may be advantageous to consider in AFPM machine design, especially where uniform air gaps are required. It is shown that the semi-closed slot has a significant effect on the torque or output power increase of the inner rotor dual sided stator geometry and may be considered in the design to achieve high power density without increasing the motor size. For inner stator dual sided rotor motors requiring low losses, it is shown that semi-closed slots and magnetic wedges can provide advantages relative to other configurations. Example magnetic wedge heights may be at least 1 mm, between 0.5 mm and 20 mm, between 0.5 mm and 5 mm, between 0.5 mm and 3 mm, between 1 mm and 5 mm, between 1 mm and 2 mm, between 1 mm and 1.5 mm, between 1.5 mm and 2 mm, between 1.5 mm and 2 mm, at least 2 mm, between 1/100^{th} and ¾ of a width of a respective slot in which the magnetic wedge is positioned (e.g., referred to herein as a respective slot width), between 1/20^{th} and ½ of a respective slot width, between 1/20^{th} and ⅙^{th} of a respective slot width, between 1/12^{th} and ¾ of a respective slot width, between 1/12^{th} and ½ of a respective slot width, between 1/12^{th} and ⅙^{th} of a respective slot width, between ⅛^{th} and ⅙^{th} of a respective slot width, between ⅛^{th} and ¾ of a respective slot width, and/or between ⅙^{th} and ¾ of a respective slot width. Any or all of the ranges of magnetic wedge height described above provides an advantage of reducing or eliminating irreversible demagnetization of permanent magnets in the motor. The analyzed results are expected to be helpful to AFPM machine designers in understanding the impact of semiclosed slots and magnetic wedges on AFPM machines and providing solutions for design optimization for each topology.

### VI. Example Embodiments

In a first example, a permanent magnet motor, comprises a rotor core, one or more permanent magnets, each of the one or more permanent magnets having a composition that includes a selected percentage of rare-earth materials and having a respective magnet depth that is at least 7.015 mm or a respective magnet depth to air gap length ratio between 13 and 26, wherein the respective magnet depth of a respective magnet of the one or more permanent magnets is measured from a first end of the respective permanent magnet adjacent to the rotor core to a second end of the respective permanent magnet opposite of the first end, and a stator comprising a stator core and a plurality of stator teeth extending from the stator core toward the one or more permanent magnets and the rotor core, wherein adjacent teeth of the plurality of stator teeth are separated from one another by respective slots having respective slot widths, and wherein the plurality of stator teeth each have a respective tooth width ratio that is at least 0.1126, wherein the respective tooth width ratio is a normalized ratio of a tooth width of a respective tooth of the plurality of stator teeth to the slot width.

A second example includes the first example, and further includes the permanent magnet motor, wherein each respective tooth of the plurality of stator teeth further comprises a respective tooth tip extending away from an end of the respective tooth toward the rotor core, the respective tooth tip having a greater width than the respective tooth, and the respective tooth tip forming a slot opening having a slot opening width extending between the respective tooth tip and an adjacent tooth tip of an adjacent tooth of the plurality of stator teeth, wherein a slot opening width ratio between the slot opening width and the slot width is less than or equal to 0.2350.

A third example includes the first and/or second examples, and further includes the permanent magnet motor, wherein the respective magnet depth is between 8.49 mm and 20 mm, a magnet ratio of magnet depth to air gap length is between 13.559 and 25.424, the respective tooth width ratio is between 0.22 and 0.5, and/or the slot opening width ratio is less than or equal to 0.1586.

A fourth example includes one or more of the first through third examples, and further includes the permanent magnet motor, wherein the respective tooth tip has a tooth tip depth measured from the end of the respective tooth to an opposing end of the tooth tip, and wherein the tooth tip depth is greater than 2 mm.

A fifth example includes one or more of the first through fourth examples, and further includes the permanent magnet motor, wherein the respective tooth tip has a tooth tip depth measured from the end of the respective tooth to an opposing end of the tooth tip, and wherein the tooth tip depth is greater than or equal to 3 mm.

A sixth example includes one or more of the first through fifth examples, and further includes the permanent magnet motor, wherein the respective tooth tip is angled relative to side edges of the respective tooth at an angle that is greater than or equal to 0°.

A seventh example includes one or more of the first through sixth examples, and further includes the permanent magnet motor, wherein the respective tooth tip is angled relative to side edges of the respective tooth at an angle that is less than or equal to 10°.

An eighth example includes one or more of the first through seventh examples, and further includes the permanent magnet motor, wherein the permanent magnet motor comprises a surface permanent magnet synchronous motor or an interior permanent magnet synchronous motor.

A ninth example includes one or more of the first through eighth examples, and further includes the permanent magnet motor, wherein the one or more permanent magnets includes one or more rare-earth-free permanent magnets, and wherein the selected percentage of rare-earth materials in the one or more rare-earth-free permanent magnets is 0%.

A tenth example includes one or more of the first through ninth examples, and further includes the permanent magnet motor, wherein the one or more permanent magnets includes one or more rare-earth-lean permanent magnets, and wherein the selected percentage of rare-earth materials in the one or more rare-earth-free permanent magnets is greater than 0% and less than a reference percentage of rare-earth materials of a reference rare-earth permanent magnet.

An eleventh example includes one or more of the first through tenth examples, and further includes the permanent magnet motor, wherein the one or more permanent magnets includes one or more rare-earth permanent magnets, and wherein the selected percentage of rare-earth materials in the one or more rare-earth-free permanent magnets is greater than 0%.

A twelfth example includes one or more of the first through eleventh examples, and further includes the permanent magnet motor, wherein the respective slots include one or more respective magnetic wedges disposed therein, each of the one or more respective wedges having a respective wedge height measured in a direction that is perpendicular to the slot width for the respective slots.

A thirteenth example includes one or more of the first through twelfth examples, and further includes the permanent magnet motor, wherein the respective wedge height is between 1.0 mm and 2.00 mm.

A fourteenth example includes one or more of the first through thirteenth examples, and further includes the permanent magnet motor, wherein the respective wedge height is selected as a function of the slot width.

A fifteenth example includes one or more of the first through fourteenth examples, and further includes the permanent magnet motor, wherein the respective wedge height is between 1/12^{th} and ⅙^{th} of the slot width.

A sixteenth example includes one or more of the first through fifteenth examples, and further includes the permanent magnet motor, wherein the stator comprises a dual sided stator or the rotor core is included in a dual sided rotor.

A seventeenth example includes a stator for a permanent magnet motor, the stator comprising: a stator core, and a plurality of stator teeth, wherein adjacent teeth of the plurality of stator teeth are separated from one another by respective slots having respective slot width, and wherein the plurality of stator teeth each have a respective tooth width ratio that is at least 0.1126 and, wherein the respective tooth width ratio is a ratio of a tooth width of a respective tooth of the plurality of stator teeth and the slot width.

An eighteenth example includes the seventeenth example and further includes the stator, wherein each respective tooth of the plurality of stator teeth further comprises a respective tooth tip extending away from an end of the respective tooth, the respective tooth tip having a greater width than the respective tooth, and the respective tooth tip forming a slot opening having a slot opening width extending between the respective tooth tip and an adjacent respective tooth tip of an adjacent tooth of the plurality of stator teeth, wherein a slot opening width ratio between the slot opening width and the slot width is less than or equal to 0.2350.

A nineteenth example includes the seventeenth and/or eighteenth examples, and further includes the stator, wherein the respective tooth width ratio is at least 0.22, and/or the slot opening width ratio is less than or equal to 0.1586.

A twentieth example includes one or more of the seventeenth through nineteenth examples, and further includes the stator, wherein the respective tooth tip has a tooth tip depth measured from the end of the respective tooth to an opposing end of the tooth tip, and wherein the tooth tip depth is greater than 2 mm.

A twenty-first example includes one or more of the seventeenth through twentieth examples, and further includes the stator, wherein the respective tooth tip has a tooth tip depth measured from the end of the respective tooth to an opposing end of the tooth tip, and wherein the tooth tip depth is greater than or equal to 3 mm.

A twenty-second example includes one or more of the seventeenth through twenty-first examples, and further includes the stator, wherein the respective tooth tip is angled relative to side edges of the respective tooth at an angle that is greater than 0°.

A twenty-third example includes one or more of the seventeenth through twenty-second examples, and further includes the stator, wherein the respective tooth tip is angled relative to side edges of the respective tooth at an angle that is between 1.4° and 10°.

A twenty-fourth example includes one or more of the seventeenth through twenty-third examples, and further includes the stator, wherein the stator is included in the permanent magnet motor with one or more permanent magnets having a respective magnet depth that is between 7.015 mm and 20 mm.

A twenty-fifth example includes one or more of the seventeenth through twenty-fourth examples, and further includes the stator, wherein the respective magnet depth is between 8.49 mm and 20 mm.

A twenty-sixth example includes one or more of the seventeenth through twenty-fifth examples, and further includes the stator, wherein the one or more permanent magnets are free of rare earth materials.

A twenty-seventh example includes one or more of the seventeenth through twenty-sixth examples, and further includes the stator, wherein the one or more permanent magnets are rare-earth-lean magnets.

A twenty-eighth example includes one or more of the seventeenth through twenty-seventh examples, and further includes the stator, wherein the permanent magnet motor comprises a surface permanent magnet synchronous motor.

A twenty-ninth example includes a method of manufacturing the permanent magnet motor of one or more of the first through sixteenth examples.

A thirtieth example includes a method of manufacturing the stator of one or more of the seventeenth through twenty-eighth examples.

A thirty-first example includes a permanent magnet motor, comprising: a rotor core; one or more permanent magnets, each of the one or more permanent magnets being free of rare-earth materials and having a respective magnet depth, wherein the respective magnet depth of a respective magnet of the one or more permanent magnets is measured from a first end of the respective permanent magnet adjacent to the rotor core to a second end of the respective permanent magnet opposite of the first end, and a stator comprising a stator core and a plurality of stator teeth extending from the stator core toward the one or more permanent magnets and the rotor core, wherein adjacent teeth of the plurality of stator teeth are separated from one another by respective slots having respective slot width, and wherein the plurality of stator teeth each have a respective tooth width ratio, wherein the respective tooth width ratio is a normalized ratio of a tooth width of a respective tooth of the plurality of stator teeth to the slot width, wherein the respective magnet depth and the respective tooth width ratio are selected to achieve a demagnetization ratio of less than 0.1% for the permanent magnet motor.

A thirty-second example includes the thirty-first example, and further includes the permanent magnet motor, wherein the respective magnet depth and the respective tooth width ratio are selected by executing simulations using finite element analysis (FEA) models and selecting the respective magnet depth and the respective tooth width ratio to achieve a demagnetization ratio of less than 0.1% for the permanent magnet motor based on results of the simulations using the FEA models.

A thirty-third example includes the thirty-first example and/or the thirty-second example, and further includes the permanent magnet motor, wherein the adjacent teeth of the plurality of stator teeth are arranged in a slotless configuration with a slot opening of 0 mm.

### VI. Conclusion

This disclosure investigates the effect of tooth tip design on air gap flux density modulation and, consequently, irreversible demagnetization in PMSMs. This work focuses the investigation on low-temperature irreversible demagnetization in MnBi SPMSMs because of the unique BH characteristics of this promising, relatively immature PM material and the relatively high risk of irreversible demagnetization in the SPMSM. MnBi coercivity increases significantly with temperature, making temperature-dependent irreversible demagnetization at and below room temperature a concern for configurations. The study suggests that a small slot opening width and sufficiently deep tooth tips to prevent excessive tooth tip saturation minimizes air gap flux density modulation due to slotting effects, thereby reducing low temperature irreversible demagnetization risk in MnBi SPMSMs. These guidelines apply to other RE, RE-lean, and RE-free topologies, including IPMSM topologies for which irreversible demagnetization limits performance. Rare-earth magnets may include magnets made from alloys of rare-earth elements, including but not limited to samarium cobalt and neodymium magnets. RE-free may refer to magnets that utilize no or substantially no RE elements (e.g., 0%), while RE-lean may refer to magnets that utilize a percentage of RE elements that is less than a reference RE PM configuration as well as RE PM magnets that do not utilize particular RE elements (e.g., RE elements defined in some contexts as being more critical than manganese, such as neodymium and dysprosium).

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods.

As used herein, the terms “a”, “an”, and “at least one” encompass one or more of the specified element. That is, if two of a particular element are present, one of these elements is also present and thus “an” element is present. The terms “a plurality of” and “plural” mean two or more of the specified element. As used herein, the term “and/or” used between the last two of a list of elements means any one or more of the listed elements. For example, the phrase “A, B, and/or C” means “A”, “B,”, “C”, “A and B”, “A and C”, “B and C”, or “A, B, and C.” As used herein, the term “coupled” generally means physically or chemically coupled or linked and does not exclude the presence of intermediate elements between the coupled items absent specific contrary language.

Although there are alternatives for various components, angles, dimensions, parameters, operating conditions, etc., set forth herein, that does not mean that those alternatives are necessarily equivalent and/or perform equally well. Nor does it mean that the alternatives are listed in a preferred order unless stated otherwise. The disclosure of numerical ranges should be understood as referring to each discrete point within the range, inclusive of endpoints, unless otherwise noted. Unless otherwise indicated, all numbers expressing quantities of components, molecular weights, percentages/ratios, sizes, temperatures, times, and so forth, as used in the specification or claims may be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art.

In view of the many possible embodiments to which the principles of the disclosed technology may be applied, it should be recognized that the illustrated embodiments are only examples and should not be taken as limiting the scope of the disclosure. Rather, the scope of the disclosure is at least as broad as the following claims. We therefore claim all that comes within the scope of the following claims.

1. A permanent magnet motor, comprising:
a rotor core;
one or more permanent magnets, each of the one or more permanent magnets having a composition that includes a selected percentage of rare-earth materials and having a respective magnet depth that is at least 7.015 mm or a respective magnet depth to air gap length ratio between 13 and 26, wherein the respective magnet depth of a respective magnet of the one or more permanent magnets is measured from a first end of the respective permanent magnet adjacent to the rotor core to a second end of the respective permanent magnet opposite of the first end; and
a stator comprising a stator core and a plurality of stator teeth extending from the stator core toward the one or more permanent magnets and the rotor core, wherein adjacent teeth of the plurality of stator teeth are separated from one another by respective slots having respective slot widths, and wherein the plurality of stator teeth each have a respective tooth width ratio that is at least 0.1126, wherein the respective tooth width ratio is a normalized ratio of a tooth width of a respective tooth of the plurality of stator teeth to the slot width.

2. The permanent magnet motor of claim 1, wherein each respective tooth of the plurality of stator teeth further comprises a respective tooth tip extending away from an end of the respective tooth toward the rotor core, the respective tooth tip having a greater width than the respective tooth, and the respective tooth tip forming a slot opening having a slot opening width extending between the respective tooth tip and an adjacent tooth tip of an adjacent tooth of the plurality of stator teeth, wherein a slot opening width ratio between the slot opening width and the slot width is less than or equal to 0.2350.

3. The permanent magnet motor of claim 1, wherein the respective magnet depth is between 8.49 mm and 20 mm, a magnet ratio of magnet depth to air gap length is between 13.559 and 25.424, the respective tooth width ratio is between 0.22 and 0.5, and/or the slot opening width ratio is less than or equal to 0.1586.

4. The permanent magnet motor of claim 1, wherein the respective tooth tip has a tooth tip depth measured from the end of the respective tooth to an opposing end of the tooth tip, and wherein the tooth tip depth is greater than 2 mm.

5. The permanent magnet motor of claim 1, wherein the respective tooth tip is angled relative to side edges of the respective tooth at an angle that is greater than or equal to 0° and less than or equal to 10°.

6. The permanent magnet motor of claim 1, wherein the permanent magnet motor comprises a surface permanent magnet synchronous motor or an interior permanent magnet synchronous motor.

7. The permanent magnet motor of claim 1, wherein the one or more permanent magnets includes one or more rare-earth-free permanent magnets, and wherein the selected percentage of rare-earth materials in the one or more rare-earth-free permanent magnets is 0%.

8. The permanent magnet motor of claim 1, wherein the one or more permanent magnets includes one or more rare-earth-lean permanent magnets, and wherein the selected percentage of rare-earth materials in the one or more rare-earth-lean permanent magnets is greater than 0% and less than a reference percentage of rare-earth materials of a reference rare-earth permanent magnet.

9. The permanent magnet motor of claim 1, wherein the respective slots include one or more respective magnetic wedges disposed therein, each of the one or more respective wedges having a respective wedge height measured in a direction that is perpendicular to the slot width for the respective slots.

10. The permanent magnet motor of claim 9, wherein the respective wedge height is between 1.0 mm and 2.00 mm or between 1/12^{th} and ⅙^{th} of the slot width.

11. The permanent magnet motor of claim 1, wherein the stator comprises a dual sided stator or the rotor core is included in a dual sided rotor.

12. A stator for a permanent magnet motor, the stator comprising:
a stator core; and
a plurality of stator teeth, wherein adjacent teeth of the plurality of stator teeth are separated from one another by respective slots having respective slot width, and wherein the plurality of stator teeth each have a respective tooth width ratio that is at least 0.1126 and, wherein the respective tooth width ratio is a ratio of a tooth width of a respective tooth of the plurality of stator teeth and the slot width.

13. The stator of claim 12, wherein each respective tooth of the plurality of stator teeth further comprises a respective tooth tip extending away from an end of the respective tooth, the respective tooth tip having a greater width than the respective tooth, and the respective tooth tip forming a slot opening having a slot opening width extending between the respective tooth tip and an adjacent respective tooth tip of an adjacent tooth of the plurality of stator teeth, wherein a slot opening width ratio between the slot opening width and the slot width is less than or equal to 0.2350.

14. The stator of claim 13, wherein the respective tooth width ratio is at least 0.22, and/or the slot opening width ratio is less than or equal to 0.1586.

15. The stator of claim 13, wherein the respective tooth tip has a tooth tip depth measured from the end of the respective tooth to an opposing end of the tooth tip, and wherein the tooth tip depth is greater than 2 mm.

16. The stator of claim 13, wherein the respective tooth tip is angled relative to side edges of the respective tooth at an angle that is between 1.4° and 10°.

17. The stator of claim 12, wherein the stator is included in the permanent magnet motor with one or more permanent magnets having a respective magnet depth that is between 7.015 mm and 20 mm, wherein the one or more permanent magnets are free of rare earth materials or are rare-earth-lean magnets, and wherein the permanent magnet motor comprises a surface permanent magnet synchronous motor.

18. A permanent magnet motor, comprising:
a rotor core;
one or more permanent magnets, each of the one or more permanent magnets being free of rare-earth materials and having a respective magnet depth, wherein the respective magnet depth of a respective magnet of the one or more permanent magnets is measured from a first end of the respective permanent magnet adjacent to the rotor core to a second end of the respective permanent magnet opposite of the first end; and
a stator comprising a stator core and a plurality of stator teeth extending from the stator core toward the one or more permanent magnets and the rotor core, wherein adjacent teeth of the plurality of stator teeth are separated from one another by respective slots having respective slot width, and wherein the plurality of stator teeth each have a respective tooth width ratio, wherein the respective tooth width ratio is a normalized ratio of a tooth width of a respective tooth of the plurality of stator teeth to the slot width, wherein the respective magnet depth and the respective tooth width ratio are selected to achieve a demagnetization ratio of less than 0.1% for the permanent magnet motor.

19. The permanent magnet motor of claim 18, wherein the respective magnet depth and the respective tooth width ratio are selected by executing simulations using finite element analysis (FEA) models and selecting the respective magnet depth and the respective tooth width ratio to achieve a demagnetization ratio of less than 0.1% for the permanent magnet motor based on results of the simulations using the FEA models.

20. The permanent magnet motor of claim 18, wherein the adjacent teeth of the plurality of stator teeth are arranged in a slotless configuration with a slot opening of 0 mm.
